(19) United States
(12) Patent Application Publication
(10) Pub. No.: US 2020/0100515 A1
(43) Pub. Date: Apr. 2, 2020

(54) METHOD AND COMPOSITION COMPRISING HYDROLYZED STARCH AND STABILIZERS

(71) Applicant: The Quaker Oats Company, Chicago, IL (US)

(72) Inventors: Zeinab Ali, Barrington, IL (US); Pietro Caruso, Plainsboro, NJ (US); Connie Cerdena, Barrington, IL (US); Kathlene McManus, Barrington, IL (US); Gopinathan Meletharayil, Rosemont, IL (US); Brian Yu, Barrington, IL (US)

(21) Appl. No.: 16/579,344

(22) Filed: Sep. 23, 2019

Related U.S. Application Data
(60) Provisional application No. 62/737,568, filed on Sep. 27, 2018.

(51) Int. Cl. A23C 11/10; A23L 2/66; A23L 2/60; A23L 2/56

(52) U.S. Cl. CPC A23C 11/10; A23L 2/56; A23L 2/60; A23L 2/66

(57) ABSTRACT

An oat composition comprising water, hydrolyzed oats, undissolved solids, dissolved solids, emulsifier, and suspension stabilizer. The hydrolyzed oats are 1 to 10% by weight of the oat composition and can be whole grain. The suspension stabilizer concentration is effective to maintain the undissolved solids in suspension in the oat composition upon activation so that at least 90% by volume of the oat composition is a single solid-in-liquid suspension at the end of a suspension test, where the solid-in-liquid suspension comprises water and a majority the undissolved solids in the oat composition. The viscosity of the oat composition is 6 to 30 cP at 8° C. at a shear rate of 50/s. The hydrolyzed oats are provided by hydrolyzing starch in starting oats comprising a pre-hydrolysis starch-to-protein mass ratio. The hydrolyzed oats comprise a post-hydrolysis starch-to-protein mass ratio equal to the pre-hydrolysis starch-to-protein mass ratio within a tolerance of +/−10%.

The present application claims priority to U.S. Patent Application 62/737,568 filed Sep. 27, 2018, the entire contents of which is incorporated herein by reference.

The present disclosure relates to providing an oat composition. For example, the oat composition can comprise water, whole grain oats having hydrolyzed starch, solids (e.g., undissolved solids, dissolved solids or a combination thereof), emulsifier, and suspension stabilizer.

### BACKGROUND

In one aspect, the disclosure also relates to oat milk compositions that can be used as an alternative to dairy milk.

In a second aspect, the disclosure relates to a beverage made from hydrolyzed whole grain oat.

In a third aspect, the disclosure relates to a liquid or semi-liquid/semi-solid composition.

In a fourth aspect, the disclosure relates to a composition comprising whole grain or various advantages associated with whole grain compositions. For example, the disclosure relates to a composition in which the starch in whole grain oat flour has been partially hydrolyzed under controlled conditions. The controlled conditions can be configured to avoid conversion of starch to non-starch components like sugar (e.g., simple sugars). Likewise, a desired fiber content in the whole grain can be maintained, a desired beta-glucan content in the whole grain can be maintained, and harm to the beta-glucan can be avoided. As a result, in some embodiments, health benefits associated with oats, the whole grain status of oats, their fiber concentration, their beta-glucan concentration, or a combination thereof, can be maintained in the final oat composition. Meanwhile, as a result of hydrolyzing the whole grain oats, an oat composition comprising the hydrolyzed whole grain oats can also provide enhanced organoleptic properties, for example, reduced viscosity, reduced sliminess, desired taste, or a combination thereof.

In a fifth aspect, the disclosure relates to potential uses of a composition as described herein. For example, the composition can serve as a glycemic index reducer, immunity enhancer, energy enhancer, fiber source, soluble fiber source, nutrient additive, texture modifier, viscosity modifier, or a combination thereof. Moreover, the viscosity of the final oat composition can be tailored by controlling the particle size of the hydrolyzed whole grain oats, and by adding emulsifiers and suspension stabilizers.

Although alternatives to dairy products exist in the market, existing products tend to lack one or more potentially desirable features. For example, existing products can lack a desired concentration of a component (e.g., grain, soluble fiber, whole grain, or beta-glucan), health benefits associated with the desired concentration of the component in a product, enhanced organoleptic properties, reduced viscosity, reduced sliminess, desired taste, desired pH, or a combination thereof. For example, existing products can fall short of adequately emulating dairy products in the area of mouth feel and sensory attributes. Additionally, existing products can also fall short of providing health benefits desired by consumers.

### SUMMARY

In a first aspect, the present invention provides an oat composition comprising water, hydrolyzed whole grain oats, undissolved solids, dissolved solids, emulsifier, and suspension stabilizer. The hydrolyzed whole grain oats comprise hydrolyzed starch and are present in the oat composition at 1 to 10 wt. % of the oat composition. The suspension stabilizer is present in the oat composition at a concentration that is effective to maintain the undissolved solids in suspension in the oat composition.

The undissolved solids are deemed to be maintained in suspension if at least 90% by volume of the oat composition is a single solid-in-liquid suspension at the end of a suspension test, where the solid-in-liquid suspension comprises water and a majority of the undissolved solids in the oat composition. The suspension test comprises: (i) providing 100 mL of the oat composition at 20° C. in a graduated cylinder and in air at 20° C., the graduated cylinder having an inner diameter of 3 cm, having an inner height of 25 cm and being configured to measure at least 100 mL of water contained by the graduated cylinder; (ii) closing the graduated cylinder so that the oat composition will not escape from the graduated cylinder during a mixing step; (iii) performing the mixing step by vertically orienting a central axis of the graduated cylinder and vertically oscillating the graduated cylinder at an amplitude of 2.5 cm so that the graduated cylinder is displaced 2.5 cm above and 2.5 cm below a starting position at a rate of 1 oscillation per second for 15 seconds; and (iv) allowing the graduated cylinder to remain stationary for 2 hours after the mixing step.

The viscosity of the oat composition is 6 to 30 cP at 8° C. and at a shear rate of 50/s.

The hydrolyzed whole grain oats are provided by hydrolyzing starch in starting whole grain oats comprising a pre-hydrolysis starch-to-protein mass ratio. The hydrolyzed whole grain oats comprise a post-hydrolysis starch-to-protein mass ratio. The post-hydrolysis starch-to-protein mass ratio is equal to the pre-hydrolysis starch-to-protein mass ratio within a tolerance of +/−10% of the pre-hydrolysis starch-to-protein mass ratio.

In a second aspect, the invention provides a method for making an oat composition. The method comprises several steps. A first step comprises hydrolyzing starch in starting whole grain oats to provide hydrolyzed whole grain oats, which comprise hydrolyzed starch.

A second step comprises combining the hydrolyzed whole grain oats, water, emulsifier and suspension stabilizer to provide the oat composition, which comprises water, hydrolyzed whole grain oats, undissolved solids, dissolved solids, emulsifier and suspension stabilizer. The hydrolyzed whole grain oats comprise hydrolyzed starch and make up 1 to 10 wt. % of the oat composition. The suspension stabilizer is present in the oat composition at a concentration that is effective to maintain the undissolved solids in suspension in the oat composition.

The undissolved solids are deemed to be maintained in suspension if at least 90% by volume of the oat composition is a single solid-in-liquid suspension at the end of a suspension test, where the solid-in-liquid suspension comprises water and a majority of the undissolved solids in the oat composition. The suspension test comprises: (i) providing 100 mL of the oat composition at 20° C. in a graduated cylinder and in air at 20° C., the graduated cylinder having an inner diameter of 3 cm, having an inner height of 25 cm and being configured to measure at least 100 mL of water contained by the graduated cylinder; (ii) closing the graduated cylinder so that the oat composition will not escape from the graduated cylinder during a mixing step; (iii) performing the mixing step by vertically orienting a central axis of the graduated cylinder and vertically oscillating the graduated cylinder at an amplitude of 2.5 cm so that the graduated cylinder is displaced 2.5 cm above and 2.5 cm below a starting position at a rate of 1 oscillation per second for 15 seconds; and (iv) allowing the graduated cylinder to remain stationary for 2 hours after the mixing step.

The viscosity of the oat composition is 6 to 30 cP at 8° C. and at a shear rate of 50/s.

In the first step, the hydrolyzed whole grain oats are provided by hydrolyzing starch in the starting whole grain oats. The starting whole grain oats comprise a pre-hydrolysis starch-to-protein mass ratio. The hydrolyzed whole grain oats comprise a post-hydrolysis starch-to-protein mass ratio. The post-hydrolysis starch-to-protein mass ratio is equal to the pre-hydrolysis starch-to-protein mass ratio within a tolerance of +/−10% of the pre-hydrolysis starch-to-protein mass ratio.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar components that are illustrated in various figures are generally represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a schematic block flow diagram illustrating an embodiment of a process for producing an oat composition of the present disclosure.

FIG. 2 depicts a schematic block flow diagram illustrating an embodiment of a process for producing hydrolyzed whole grain oats or a hydrolyzed product composition.

FIG. 3 depicts a schematic illustration of a graduated cylinder filled with contents and having a head space above the contents so that oscillation of the graduated cylinder can be used to mix the contents as part of a suspension test.

### DETAILED DESCRIPTION

One of the challenges with producing dairy alternatives is emulating the mouth feel and taste profile of dairy beverages. For example, alternatives such as soy milk, almond milk, cashew milk and coconut milk can differ from dairy milk with respect to viscosity and settling of insoluble solids. The inventors have discovered how to tailor these and other attributes in whole oat grain beverages to provide a product with desired organoleptic properties, desired health-related benefits, or a combination thereof. Moreover, the inventors have developed a method of making a beverage composition from whole grain oats such that the “whole grain” status of the oats can be maintained in the final beverage composition while also providing desired organoleptic properties.

With respect to potentially desirable health attributes, it can be desirable to prepare a whole oat product that has sufficient soluble fiber to meet the FDA threshold necessary to justify a health claim. For example, a whole oat or barley product must have 0.75 g soluble beta-glucan fiber per serving of food to support a health claim under the most recent effective version of 21 C.F.R. 101.81, which is incorporated herein by reference as an example. To prepare an oat beverage that contains at least 0.75 g soluble oat fiber per serving (about 18 g of whole grain oats), it can be beneficial to use highly dispersible oat flour that also retains its whole grain standard. “Studies show that eating whole grains instead of refined grains lowers the risk of many chronic diseases. While benefits are most pronounced for those consuming at least 3 servings daily, some studies show reduced risks from as little as one serving daily.” (See, e.g., wholegrainscouncil.org, “Whole Grains 101,” “Health Studies,” “What Are the Health Benefits?” available at https://wholegrainscouncil.org/whole-grains-101/health-studies-health-benefits/what-are-health-benefits (last accessed Apr. 27, 2018). Note that 1 full serving of whole grain is 16 g.

In some embodiments, the oat composition (or other whole grain) made in accordance with the methods described herein maintains its standard of identity as whole grain throughout processing (e.g., starch hydrolysis, pelletizing, drying, and/or grinding). “Whole grain” or “standard of identity as whole grain” shall mean that the cereal grain, for example, oat, “consists of the intact, ground cracked or flaked caryopsis, whose principal anatomical components—the starchy endosperm, germ and bran—are present in approximately the same relative proportions as they exist in the intact caryopsis.” (See, AACC International's Definition of “Whole Grains,” approved in 1999, available at http://www.aaccnet.org/initiatives/definitions/pages/wholegrain.aspx (last accessed Apr. 20, 2018).) Further, if the principal nutrients (i.e., starch, fat, protein, dietary fiber, beta-glucan, and sugar) are present in approximately the same relative proportions for a partially hydrolyzed grain and the original grain, it can be assumed that the processed grain (e.g., the partially hydrolyzed grain) maintains its whole grain status. However, since the average molecular weight of starch (e.g., amylopectin) in whole grains varies widely across the various types of whole grains (e.g., 1-400 million Dalton) and even among whole grain oat products, a shift in starch moieties from higher molecular weight to lower molecular weight does not alter whole grain status if the total starch content remains the same.

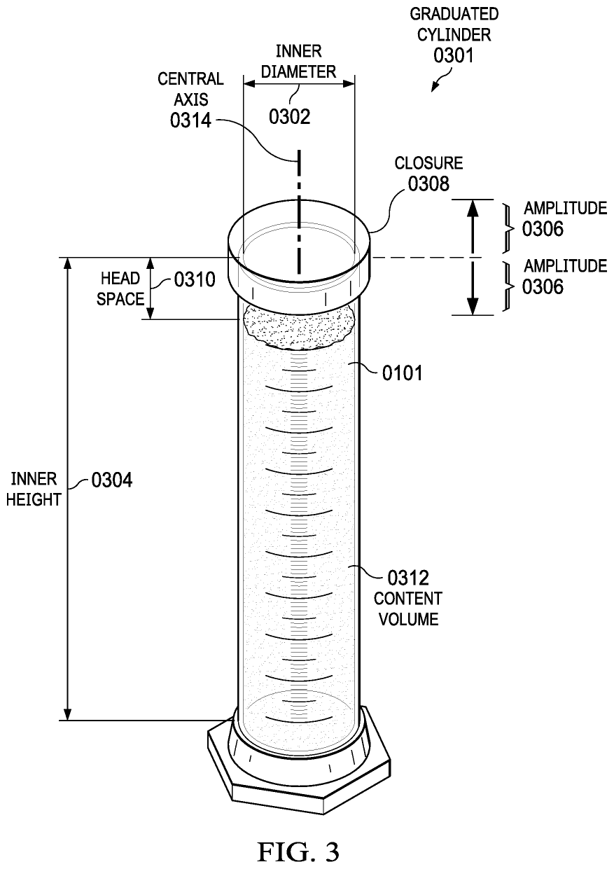

In some embodiments, aspects of the present disclosure relate to an oat composition 0101 comprising water 0106, 1 to 10 wt. % (e.g., 2.2 to 4.3 wt. % or 3.3 to 6.7 wt. %) of hydrolyzed whole grain oats 0104 comprising hydrolyzed starch, undissolved solids, dissolved solids, emulsifier 0108 (i.e., emulsion stabilizer) and a concentration of suspension stabilizer 0109 effective to maintain the undissolved solids in suspension in the oat composition 0101 so that at least 90% (e.g., at least 90, 91, 92, 93, 94, 95, 96, 97, 98 or 99% and up to 100%) by volume of the oat composition 0101 is a single solid-in-liquid suspension at the end of a suspension test, where the solid-in-liquid suspension comprises water and a majority (e.g., more than 50 wt. %, at least 90 wt. %, or more than 90 wt. %) of the undissolved solids in the oat composition. Examples of undissolved solids can include solids from oats, insoluble calcium salts (e.g., tricalcium phosphate), or a combination thereof. Examples of dissolved solids or soluble solids can include solids from oats, sugar, soluble salts (e.g., NaCl), or a combination thereof. As can be seen with reference to FIG. 3, the suspension test used to measure percent suspension can comprise several steps. A first step comprises providing 100 mL of the oat composition 0101 at 20° C. in a graduated cylinder 0301 and in air at 20° C. No special pressure regulation is required for the experiment, which can be conducted at local atmospheric pressure or in an air conditioned room. Although, the experiment can also be conducted in a pressure-controlled chamber at a standard sea-level pressure equal to 101.325 kPa. The graduated cylinder has an inner diameter 0302 of 3 cm, has an inner height 0304 of 25 cm (e.g., to provide a head space 0310) and is configured to measure at least 100 mL of water (e.g., to provide a content volume 0312 that is measurable to at least 100 mL) contained by the graduated cylinder 0301. A second step comprises closing the graduated cylinder 0301 (e.g. with a closure 0308) so that the oat composition 0101 will not escape from the graduated cylinder 0301 during a mixing step. A third step comprises performing the mixing step by vertically orienting a central axis 0314 of the graduated cylinder and vertically oscillating the graduated cylinder 0301 at an amplitude 0306 equal to 2.5 cm so that the graduated cylinder is displaced 2.5 cm above and 2.5 cm below a starting position at a rate of 1 oscillation per second for 15 seconds. A fourth step comprises allowing the graduated cylinder 0301 to remain stationary for 2 hours after the mixing step.

In some embodiments, the viscosity of the oat composition 0101 is 6 to 30 cP at 8° C. and at a shear rate of 50/s (e.g., 50 dimensionless radians per second, which is equivalent to approximately 8 rotations per second) as measured using a rheometer (e.g., MCR 92 Rheometer available from ANTON PAAR USA INC. of Ashland, Va., United States). The rheometer comprises a first cylinder and a second cylinder that are coaxial. The oat composition 0101 can be placed in an annular space between the first cylinder and the second cylinder. The first cylinder moves (e.g., rotates) relative to the second cylinder to subject the oat composition 0101 to the shear rate of 50/s. The rheometer measures the viscosity of the oat composition 0101 while the oat composition 0101 is subject to the shear rate of 50/s. The hydrolyzed whole grain oats are provided by hydrolyzing 0110 starch in starting whole grain oats 0102.

In some embodiments, upon accounting for and excluding the mass of any additional ingredients that are added to oats, the post-hydrolysis starch-to-protein mass ratio of the oats is equal to the pre-hydrolysis starch-to-protein mass ratio of the oats within a tolerance of +/−30, 25, 20, 15, 10, 5, 4, 3, 2 or 1% of the pre-hydrolysis starch-to-protein mass ratio. As an illustration, viewing the mass ratio X:Y as the fraction X/Y, it is possible to convert the tolerance of +/−10% of the pre-hydrolysis starch-to-protein mass ratio into an actual range, namely, X/Y−0.1*X/Y to X/Y+0.1*X/Y, which is equivalent to 0.9*X/Y to 1.1*X/Y. In some embodiments, the pre-hydrolysis starch-to-protein mass ratio can be equal to about 4.4:1 (e.g., 3.4:1 to 5.4:1). In some embodiments, the starting whole grain oats 0102 can comprise about 12.0 to 13.5 wt. % protein, about 54.0 to 56.75 wt. % starch, or a combination thereof. In some embodiments, the post-hydrolysis starch-to-protein mass ratio can be equal to about 4.1:1 (e.g., 3.1:1 to 5.1:1). In some embodiments, the hydrolyzed whole grain oats 0104 can comprise about 12.6 to 12.95 wt. % protein, about 52 to 54 wt. % starch, or a combination thereof.

In some embodiments, the post-hydrolysis fat-to-protein mass ratio is equal to the pre-hydrolysis fat-to-protein mass ratio within a tolerance of +/−30, 25, 20, 15, 10, 5, 4, 3, 2, or 1% of the pre-hydrolysis fat-to-protein mass ratio. In some embodiments, the pre-hydrolysis fat-to-protein mass ratio can be equal to about 0.59:1 (e.g., 0.5:1 to 0.71:1). In some embodiments, the starting whole grain oats 0102 can comprise about 7.4 to 8.1 wt. % fat, about 12.0 to 13.5 wt. % protein, or a combination thereof. In some embodiments, the post-hydrolysis fat-to-protein mass ratio can be equal to about 0.6:1 (e.g., 0.5:1 to 0.7:1). In some embodiments, the hydrolyzed whole grain oats 0104 can comprise about 7.0 to 7.8 wt. % fat, about 12.6 to 12.95 wt. % protein, or a combination thereof.

In some embodiments, the post-hydrolysis sugar-to-protein mass ratio is equal to the pre-hydrolysis sugar-to-protein mass ratio within a tolerance of +/−30, 25, 20, 15, 10, 5, 4, 3, 2 or 1% of the pre-hydrolysis sugar-to-protein mass ratio. In some embodiments, the pre-hydrolysis sugar-to-protein mass ratio can be equal to 0.079:1 (e.g., 0.07:1 to 0.20:1). In some embodiments, the starting whole grain oats 0102 can comprise about 0.9 to 2.6 wt. % sugar, about 12.0 to 13.5 wt. % protein, or a combination thereof. In some embodiments, the post-hydrolysis sugar-to-protein mass ratio can be equal to about 0.075:1 (e.g., 0.07:1 to 0.091:1). In some embodiments, the hydrolyzed whole grain oats 0104 can comprise about 0.86 to 1.20 wt. % sugar, about 12.6 to 12.95 wt. % protein, or a combination thereof.

In some embodiments, the post-hydrolysis beta-glucan-to-protein mass ratio is equal to the pre-hydrolysis beta-glucan-to-protein mass ratio within a tolerance of +/−30, 25, 20, 15, 10, 5, 4, 3, 2 or 1% of the pre-hydrolysis beta-glucan-to-protein mass ratio. In some embodiments, the pre-hydrolysis beta-glucan-to-protein mass ratio can be equal to about 0.26:1 (e.g., 0.25:1 to 0.3:1). In some embodiments, the starting whole grain oats 0102 can comprise about 3.2 to 3.8 wt. % beta-glucan. In some embodiments, the post-hydrolysis beta-glucan-to-protein mass ratio can be equal to about 0.27:1 (e.g., 0.26:1 to 0.4:1). In some embodiments, the hydrolyzed whole grain oats 0104 can comprise about 3.4 to 4.13 wt. % beta-glucan.

In some embodiments, a hydrolyzed product composition 0112 comprises the hydrolyzed oats (e.g., whole grain oats 0104). For example, the hydrolyzed product composition 0112 can comprise about 98.18 to 99.48 wt. % whole grain oat (e.g., flour), about 0.24 to 0.74 wt. % tocopherols, about 0.24 to 0.74 wt. % calcium silicate, about 0.04 to 0.34 wt. % alpha-amylase enzyme 0202, or a combination thereof. In some embodiments, the hydrolyzed product composition 0112 comprises about 0.24 to about 0.54 wt. % alpha-amylase enzyme. In some embodiments, the hydrolyzed product composition comprises about 6 to 12 wt. % or 6 to 10 wt. % dietary fiber, which can be included, for example, in the oats. In some embodiments, added water is combined with the whole grain oat, tocopherols, calcium silicate, alpha-amylase enzyme, additional ingredients, or a combination thereof until the hydrolyzed product composition comprises about 8 to 12 wt. % or about 8.5 to 10 wt. % total water so that the weight percentages of the other components in the hydrolyzed product are reduced as a result of the added water. In other words, if the hydrolyzed product were to be weighed before and after drying the hydrolyzed product in an oven to determine its water moisture content, the mass of the hydrolyzed product after drying would be 92 to 88% or 91.5 to 90% of the mass of the hydrolyzed product before drying. Additionally, the mass of added water can vary from 0 to 100% of the total water content in the hydrolyzed product composition but is usually less than 100% of the total water content because one or more other components (e.g., oats, etc.) in the hydrolyzed product composition can comprise water. Accordingly, it is worthwhile to point out that all the percentages given above will not necessarily add to 100 wt. % for a given composition because material included in one range can also be included in another range. For example, the oat flour can comprise water. Accordingly, some of the mass percentage of the oat flour contributes to the total water content (i.e., water moisture content) of the hydrolyzed product composition. Similarly, the oat flour can comprise dietary fiber.

In some embodiments, the oat composition 0101 comprises a dairy milk alternative, non-dairy milk or oat beverage. In some embodiments, the present disclosure relates to an oat composition 0101 comprising 0 to 8, 0 to 7, 0 to 6, 1 to 5, 1 to 4, 1.5 to 3.5, or 2.0 to 3.0 wt. % fat. For example, the oat composition 0101 can comprise about 7.18 to 7.63 wt. % fat. In some embodiments, the oat composition 0101 can comprise an oil-in-water emulsion comprising droplets of fat dispersed in water. For example, at least 90, 91, 92, 93, 94, 95, 96, 97, 98 or 99 wt. % and up to 100 wt. % of fat in the oat composition 0101 can be in an oil-in-water emulsion. In some embodiments, at least 90, 91, 92, 93, 94, 95, 96, 97, 98 or 99 wt. % and up to 100 wt. % of fat in the oat composition 0101 can have a particle size of greater than 0 micrometers and up to 10 micrometers. In some embodiments, the oat composition 0101 can be a beverage. For example, the oat composition 0101 can be a smoothie.

In some embodiments, the starting whole grain oats 0102 is in the form of a starting whole grain oat flour. For example, the hydrolyzed whole grain oats 0104 can be in the form of a hydrolyzed whole grain oat flour. The hydrolyzed whole grain oat flour can have a Dw90 particle size equal to no more than about 300 micrometers or 297 micrometers (about U.S. #50 Sieve Size) or no more than about 250 micrometers (about U.S. #60 Sieve Size) or no more than about 210 micrometers (about U.S. #70 Sieve Size). As used herein, a composition having a “Dw90 particle size” equal to no more than X micrometers means that if all the particles were arranged by size from smallest to largest using screens to provide a distribution of the particles, then upon selecting the smallest particles that provide 90 wt. % of the particles, the selected 90 wt. % of the particles can all pass through a screen having a nominal pore size equal to X micrometers or less. Determining the Dw90 particle size of a composition can be accomplished using the American Oil Chemists' Society (AOCS) Official Test Method Da 28-39, Revised 2017, entitled “Screen Test for Soap Powders,” and incorporated herein by reference. Sifting of the particles can be accomplished using Sonic Sifter Separator Model L3P from Advantech Manufacturing, Inc., of New Berlin, Wis., United States of American. For purposes of providing a standard for measuring the Dw90 particle size using a sieve sifter, the following parameters can be used: a sample size of 3 grams, a sifter frequency equal to 60 Hz, a sifter amplitude setting such that the largest particles in the sample are observed to roll on the sieve surface and no particles in the sample are observed to arc higher than ½ the height of the sifter sieve frame (e.g., a sifter amplitude setting equal to “3” on the Sonic Sifter Separator Model L3P), a test time equal to 10 minutes, and the sieve being subject to both sifting and a vertical pulse or shock wave every 4 seconds (e.g., the “sift pulse” setting is turned “on” for the Sonic Sifter Separator Model L3P).

As an example for determining a Dw90 particle size, the following measurement protocol can be used. First, a 3 g representative well-mixed sample of the material to be measured is placed on a screen (also known as a sieve) having a nominal particle size of X micrometers. Then, the screen and the representative sample are placed in a sieve shaker (e.g., Sonic Sifter Separator Model L3P from Advantech Manufacturing, Inc., with settings as specified above) that uses a vertical, oscillating column of air to cause sufficiently small particles in the representative sample to pass through the screen. The oscillation continues for 10 minutes. After the oscillation stops, if 90 wt. % or more of the mass of the representative sample has passed through the screen, the representative sample of the material has a Dw90 particle size equal to no more than X micrometers. If less than 90 wt. % of the representative sample of the material has passed through the screen, then the material does not have a Dw90 particle size equal to no more than X micrometers.

In some embodiments, the suspension stabilizer can provide 0.010 to 0.040 wt. % of the oat composition 0101 (e.g., oat beverage). For example, the suspension stabilizer 0109 can provide 0.060 to 0.15 wt. % of the oat composition 0101. As another example, the suspension stabilizer 0109 can provide 0.25 to 0.55 wt. % of the oat composition 0101. In some embodiments, the suspension stabilizer 0109 comprises a hydrocolloid. As examples of a suspension stabilizer which can be used with embodiments of the present disclosure, the suspension stabilizer 0109 can be gellan gum (e.g., high methoxy gellan gum, high acyl gellan gum, or HM-B gellan gum available from CP Kelco of Atlanta, Ga., United States of America, or a combination thereof), a composition comprising both microcrystalline cellulose (MCC) and or carboxymethyl cellulose (CMC) or a combination thereof.

In some embodiments, the oat composition 0101 comprises a viscosity of 15-20 cP at 8° C. and a shear rate of 50/s. For example, the oat composition 0101 can comprise a viscosity of 20-30 cP at 8° C. and at a shear rate of 50/s. In some embodiments, the viscosity of the oat composition 0101 is at least 6, 7, 8, 9, 10, 15 or 20 cP at 8° C. and at a shear rate of 50/s, no more than 30, 25, 20, 15, 10 cP at 8° C. and at a shear rate of 50/s, or a combination thereof. In some embodiments the hydrolyzed whole grain oats or the hydrolyzed product composition 0112 has a peak rapid visco analyzer (RVA) viscosity equal to 1500 to 2000 cP. The peak RVA viscosity can be measured using the following RVA protocol comprising several steps. The first step comprising continuously mixing the hydrolyzed whole grain oats or the hydrolyzed product composition 0112 with water 0106 by turning a shaft with a paddle at 960 rpm +/−50 rpm for 10 seconds to form a peak-RVA-test mixture comprising 14.3 wt. % total solids and a remainder of water. The second step comprising continuously stirring the peak-RVA-test mixture by turning the shaft with the paddle at 160 rpm +/−20 rpm and continuously measuring the viscosity of the peak-RVA-test mixture at least once per second during the following temperature-modification protocol: (i) maintaining the peak-RVA-test mixture at a temperature of 25° C. +/−2° C. for 90 seconds; (ii) increasing the temperature of the peak-RVA-test mixture to 95° C. +/−2° C. over 5 minutes (e.g., at a constant rate of 19° C. per minute within a tolerance of +/−2° C. per minute); (ii) maintaining the peak-RVA-test mixture at 95° C. +/−2° C. for 3 minutes; (iv) decreasing the temperature of the peak-RVA-test mixture to 25° C. +/−2° C. over 5 minutes (e.g., at a constant rate of 5° C. per minute within a tolerance of +/−2° C. per minute); and (v) maintaining the peak-RVA-test mixture at 25° C. +/−2° C. for 5 minutes. The maximum viscosity of the peak-RVA-test mixture during the RVA temperature-modification protocol (e.g., during step ii) is the peak RVA viscosity of the hydrolyzed whole grain oats or the hydrolyzed product composition. Often, the peak viscosity for the temperature-modification protocol is observed towards the end of step (ii). In some embodiments, the average molecular weight of the hydrolyzed starch molecules in the oat composition, the hydrolyzed whole grain oats or the hydrolyzed product composition is equal to 1.7×10⁵ to 7×10⁶ g/mol. For example, the average molecular weight of the hydrolyzed starch molecules in the oat composition, the whole grain oats, or the hydrolyzed product composition can be a fraction of the molecular weight of unhydrolyzed starch molecules equivalent (e.g., in kind and condition) to the hydrolyzed starch molecules, except that the unhydrolyzed starch molecules have not been hydrolyzed. In some embodiments, the fraction is about 0.27 to 0.75.

In some embodiments, the oat composition 0101 can comprise about 3 to 12 wt. % total solids (i.e., the sum of undissolved solids and dissolved solids). In some embodiments, the oat composition 0101 can comprise about 4 to 9 wt. % total solids. In some embodiments, the pH of the oat composition can be about 6.0 to 9.0. In some embodiments, the pH of the oat composition can be about 6.0 to 8.2. For example, the pH of the oat composition can be about 7.1. In some embodiments, the oat composition 0101 can comprise more than about 75 wt. % water moisture. In some embodiments the oat composition 0101 can comprise about 88 to 97 wt. % water moisture. For example, the oat composition 0101 can comprise about 82.92 to 92.13 wt. % or about 90 to 95 wt. % water moisture. In some embodiments, the oat composition 0101 can comprise about 2.3 to 4.4 wt. % hydrolyzed product composition 0112 comprising hydrolyzed whole grain oats. For example, the oat composition 0101 can comprise about 3.4 wt. % hydrolyzed product composition 0112. In some embodiments, the oat composition 0101 can comprise about 2.2 to 4.3 wt. % hydrolyzed whole grain oats 0104. For example, the oat composition 0101 can comprise about 3.3 wt. % hydrolyzed whole grain oats 0104. In some embodiments, the oat composition 0101 can comprise about 0.8 to 1.3 wt. % inulin. For example, the oat composition 0101 can comprise 1.1 wt. % inulin. In some embodiments, the oat composition 0101 can comprise about 0.5 to 1.0 vegetable oil. For example, the oat composition 0101 can comprise about 0.75 wt. % vegetable oil. In some embodiments, the vegetable oil comprises sunflower oil. In some embodiments, the vegetable oil can be any oil derived from vegetables. In some embodiments, the oat composition 0101 can comprise about 0 to 1.0 wt. % salt. For example, the oat composition 0101 can comprise about 0.1 to 1.0 wt. % salt. For example, the salt can comprise tri-calcium phosphate, a calcium salt, sodium chloride, or a combination thereof. As another example, the oat composition 0101 can comprise about 0 to 0.4 wt. % tri-calcium phosphate. As another example, the oat composition 0101 can comprise about 0 to 0.1 wt. % purified sea salt. In some embodiments, the oat composition 0101 can comprise about 0.15 to 0.25 wt. % emulsifier (e.g., gum acacia, which is also called gum arabic). For example, the oat composition 0101 can comprise about 0.20 wt. % emulsifier (e.g., gum acacia). In some embodiments, the oat composition 0101 can comprise about 0.025 to about 0.12 wt. % suspension stabilizer (e.g., high acyl gellan gum). In some embodiments, the oat composition 0101 can comprise about 0.02 to 0.03 wt. % suspension stabilizer (e.g., high acyl gellan gum). For example, the oat composition 0101 can comprise about 0.025 wt. % suspension stabilizer (e.g., high acyl gellan gum). In some embodiments, the oat composition 0101 can comprise vitamins. For example, the oat composition 0101 can comprise up to about 0.01 wt. % vitamins. As an illustration, the oat composition 0101 can comprise about 0.0042 wt. % vitamins. In some embodiments, any vitamin can be added to deliver up to about 1 to 50% of daily value for the vitamin as recommended by the Food and Drug Administration. In some embodiments, the oat composition 0101 can comprise up to 10 wt. % added sweetener. For example, the oat composition 0101 can comprise up to 3.0 wt. % added sweetener. As another example, the oat composition can comprise no added sweetener. Alternatively, the added sweetener can comprise sugar (e.g., sucrose).

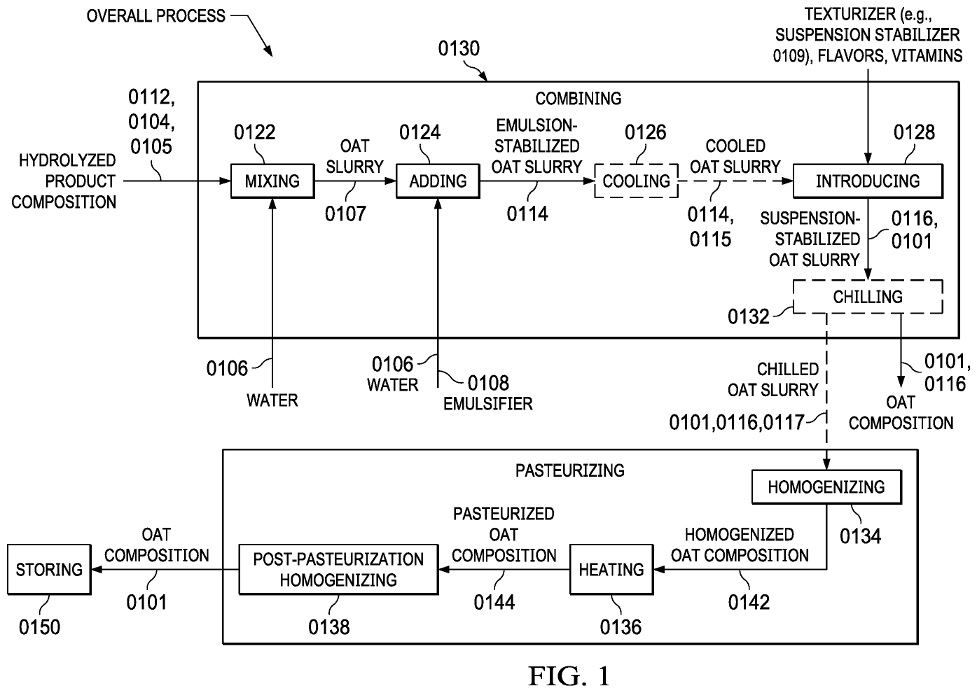

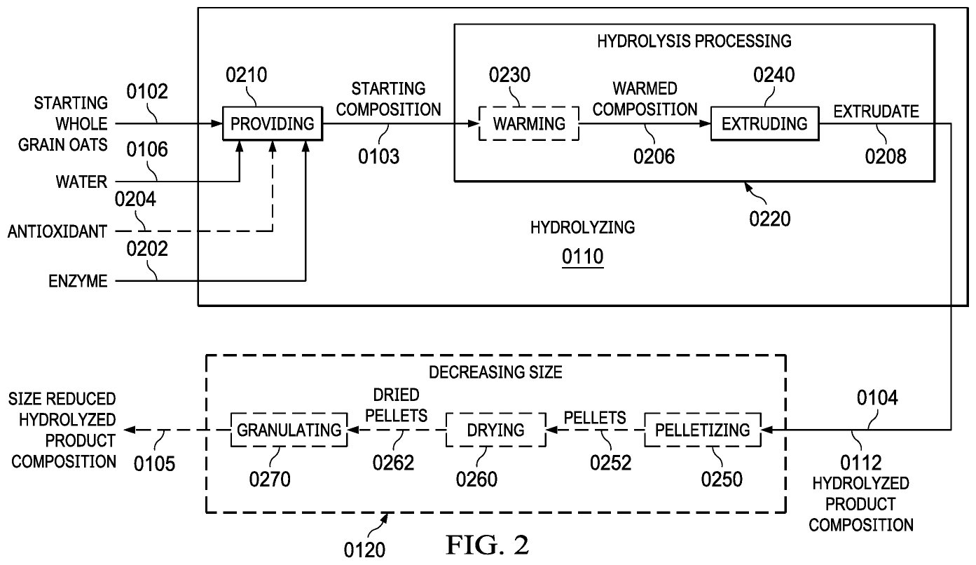

One embodiment of the present disclosure will now be described with reference to FIG. 1 and FIG. 2. FIG. 1 depicts a block flow diagram illustrating one embodiment of a process for producing an exemplary oat composition 0101 of the present disclosure. FIG. 2 depicts a block flow diagram illustrating one embodiment of a process for producing exemplary hydrolyzed whole grain oats 0104 or an exemplary hydrolyzed product composition 0112 comprising hydrolyzed whole grain oats 0104.

The process of producing an exemplary oat composition 0101 comprises a plurality of steps. A first step comprises hydrolyzing 0110 starch in starting whole grain oats 0102 to provide hydrolyzed whole grain oats 0104 comprising hydrolyzed starch. For example, the hydrolyzed whole grain oats 0104 can be provided in a hydrolyzed product composition 0112 comprising the whole grain oats 0104.

A second step comprises combining 0130 the hydrolyzed whole grain oats 0104, water 0106, emulsifier 0108, and suspension stabilizer 0109 (e.g., combining water 0106, emulsifier 0108, and suspension stabilizer 0109 with a hydrolyzed product composition 0112 comprising the hydrolyzed whole grain oats 0104) to provide an exemplary oat composition 0101. In some embodiments, water 0106 can be added to the hydrolyzed product composition 0112, which can comprise hydrolyzed whole grain oats 0104 or size-reduced hydrolyzed product composition (e.g., size reduced hydrolyzed whole grain oats 0104), before adding stabilizer 0108 and optionally additional water 0106.

With reference again to FIG. 2, the step of hydrolyzing 0110 can comprise several subsidiary steps. A first subsidiary step comprises providing 0210 a starting composition 0103 comprising starting whole grain oats 0102, an optional antioxidant 0204 (e.g. tocopherols, mixed tocopherols), water 0106, and an enzyme 0202 (e.g., alpha-amylase). In some embodiments, a mass of tocopherols in the starting composition can be about 0.4% to 0.6% (e.g., about 0.5%) of the mass of the whole grain oats in the starting composition. In some embodiments, a mass of calcium silicate in the starting composition can be about 0.4% to 0.6% (e.g., about 0.5%) of the mass of the whole grain oats in the starting composition. In some embodiments, a mass of alpha amylase enzyme in the starting composition can be about 0.1% to 0.3% (e.g., about 0.2%) of the mass of the whole grain oats in the starting composition. In some embodiments, the starting composition can comprise about 97 wt. % to about 99 wt. % (e.g. about 98.8033 wt. %) starting whole grain oats. In some embodiments, the starting composition can comprise about 0.4 wt. % to about 0.6 wt. % (e.g., about 0.4990 wt. % tocopherols). In some embodiments, the starting composition can comprise about 0.4 wt. % to about 0.6 wt. % (e.g., about 0.4990 wt. %) calcium silicate. In some embodiments, the starting composition can comprise about 0.1 wt. % to about 0.3 wt. % (e.g. about 0.1987 wt. %) alpha amylase enzyme.

A second subsidiary step comprises hydrolysis processing the alpha-amylase 0202 to enzymatically hydrolyze starch in the starting whole grain oats 0102 (e.g., in a hydrolysis reactor, extruder, conduit, etc.) to provide the hydrolyzed whole grain oats 0104 (e.g., as part of a hydrolyzed product composition 0112 that comprises the whole grain oats).

The hydrolysis processing step 0220, can, in turn, comprise substeps. For example, a first optional substep can comprise warming 0230 the starting composition 0103 to between about 120° F. (48.89° C.) and about 200° F. (93.33° C.) to begin to hydrolyze the starch (e.g., starch molecules), thereby providing a warmed composition 0206. In some embodiments, the warming step 0230 occurs in conjunction with the providing step 0210 and together make up a hydrolysis preconditioning step, which can serve to provide the starting composition 0103 at a desired temperature, with a desired mass concentration of water, and a desired mass concentration of enzyme for conducting enzymatic hydrolysis of the starch molecules in the starting composition. In some embodiments, the warming step 0230 provides a warmed mixture 0206 that can be warmed to at least about 140° F. (60° C.), 180° F. (82.22° C.), 200° F. (93.33° C.), or 212° F. (100° C.), or about 140° F. (60° C.) to about 212° F. (100° C.), or about 140° F. (60° C.) to about 180° F. (82.22° C.).

A second substep of the hydrolysis processing step 0220 can comprise an extruding step 0240, which can occur after the warming step 0230. Although the warming step does not necessarily have to occur before the extruding step 0240, it can be useful for this to occur. As an alternative, the warming 0220 can occur during the extruding step 0240 to provide the starting composition 0103 at a desired temperature for hydrolyzing the starch in the starting composition 0103. Nonetheless, when using the alternative of providing initial warming in the extruder, the initial rate of the starch hydrolysis reaction during the extruding could be lower than desired or could proceed at different rates in the composition, either of which could be undesirable, less efficient, or result in a reaction that is more difficult to control under some circumstances. With reference again to FIG. 2, the extruding step 0240 can comprise extruding 0240 the starting composition 0103 or the warmed composition 0206 (e.g., to continue hydrolyzing the starch and further to gelatinize and cook the warmed composition 0206), thereby providing a hydrolyzed product composition 0112 in the form of an extrudate 0208. In some embodiments, the dough is hydrolyzed in an extruder, and optionally the extruder comprises a barrel, which has a wall with a temperature that ranges from 180 to 300° F.

With reference to FIG. 2, the step of hydrolyzing 0110 can optionally be followed by the step of decreasing 0120 the size of particles that make up the hydrolyzed whole grain oat 0104. For example, after the extruding step 0240, the extrudate 0208 can be optionally pelletized 0250 to provide pellets 0252, optionally dried 0260 to provide dried pellets 0262, and optionally granulated 0270. For example, the granulating step 0270 can comprise grinding, milling, pulverizing, or a combination thereof to provide size-reduced hydrolyzed product composition 0105.

With reference again to FIG. 1, in some embodiments, the combining step 0130 can comprise mixing 0122 water 0106 and the hydrolyzed product composition 0112 (e.g. the hydrolyzed whole grain oat 0104, or size-reduced hydrolyzed product composition 0105) to provide an oat slurry 0107 at a temperature of about 54° C. to 66° C. For example, the mixing 0122 can comprise mixing (e.g., agitating using a high shear mixer) for 10 to 50 minutes, or 20 to 40 minutes or 25 to 35 minutes. In some embodiments, the oat slurry 0107 can comprise greater than 0 and up to about 12 wt. % total solids. In some embodiments, the oat slurry 0107 can comprise greater than 0 and up to about 12 wt. % undissolved solids. In some embodiments, the combining step 0130 can comprise adding 0124 inulin, emulsifier 0108 (e.g., gum acacia), sunflower oil, and water 0106 to the oat slurry 0107 to provide an emulsion-stabilized oat slurry 0114. In some embodiments, the combining step 0130 optionally comprises cooling 0126 the emulsion-stabilized oat slurry 0114 (e.g., to less than about 35° C.), thereby providing a cooled oat slurry 0115. In some embodiments, the combining step 0130 can comprise introducing 0128 (e.g., mixing) at least one texturizer (e.g., emulsifier, suspension stabilizer, gellan gum, gum acacia, or a combination thereof), at least one vitamin (e.g., fat soluble vitamins, which can include vitamin A, D, E, K or a combination thereof; water soluble vitamins, which can include vitamin B, C or a combination thereof; or a combination of fat and water soluble vitamins), at least one flavor (e.g., vanilla, flavors corresponding to toasted oats, or a combination thereof), or a combination thereof to the emulsion-stabilized oat slurry 0114 after the cooling step 0126 to provide an oat composition 0101 (e.g., a suspension-stabilized oat slurry 0116, which can be a flavored oat slurry). In some embodiments, the at least one texturizer (e.g., gellan gum) is added to the emulsion-stabilized oat slurry 0114 (e.g., cooled oat slurry 0115) while the emulsion-stabilized oat slurry is at a temperature from about 10 to 40 or about 15 to 35, or 20 to 30° C. As can be seen, the texturizer can be the suspension stabilizer (e.g., high acyl gellan gum). In some embodiments, the combining step 0130 optionally comprises chilling 0132 the suspension-stabilized oat slurry 0116 (e.g., flavored oat slurry, for example, to a temperature of about 2 to 6° C., after the introducing step 0128, thereby providing an oat composition 0101 (e.g., suspension-stabilized oat slurry 0116 (e.g., flavored oat slurry) or more specifically, a chilled oat slurry 0117). For example, the chilling step can be useful to satisfy food safety and quality specifications and to provide desirable attributes for processing the oat composition 0101.

With reference to FIG. 1, in some embodiments, the combining step 0130 comprises combining a salt with the oat slurry 0107 before the adding step 0124, during the adding step 0124, or a combination thereof. In some embodiments, the salt comprises tri calcium phosphate. In some embodiments, the salt comprises sodium chloride. In some embodiments, the adding step 0124 comprises adding a sweetener to the oat slurry 0107.

With reference to FIG. 1, in some embodiments, a method for making an oat composition 0101 comprises homogenizing 0134 the suspension-stabilized oat slurry 0116 (e.g., flavored oat slurry) at about 1000 psig to 3000 psig (6,894 to 20,685 kPa absolute) and optionally about room temperature (e.g., 15 to 105° C.), or optionally under chilled conditions (e.g., greater than 0 and up to 15° C.), to provide a homogenized oat composition 0142. In some embodiments, the suspension-stabilized oat slurry 0116 (e.g., flavored oat slurry) can be homogenized 0134 at about 1125 to 1875 psig (7,756 to 12,928 kPa absolute). As an illustration, the suspension-stabilized oat slurry (e.g., flavored oat slurry) can be homogenized 0134 at about 1350 to 1650 psig (9,307 to 11,377 kPa absolute) and about room temperature to provide the homogenized oat composition 0142. In some embodiments, the suspension-stabilized oat slurry 0116 (e.g., flavored oat slurry) can be homogenized 0134 at about 1500 to 2000 psig (10,342 to 13,790 kPa absolute).

In some embodiments, the method for making an oat composition 0101 can include heating 0136 the homogenized oat composition to decrease the number of viable bacteria in the homogenized oat composition (e.g., to pasteurize the homogenized oat composition to provide a pasteurized oat composition 0144). Examples of pasteurization include high temperature short time (HTST) pasteurization and ultra-heat treatment (UHT) pasteurization. Some embodiments comprise post-pasteurization-homogenizing 0138 the pasteurized oat composition at about 1000 to 3000 psig (6,894 to 20,685 kPa absolute) and at 60 to 90° C. (e.g., 70 to 90° C., or 75 to 85° C., or 82° C.) to provide the oat composition 0101. In some embodiments, the pasteurized oat composition is post-pasteurization-homogenized 0138 at about 2250 to 3750 psig (15,513 to 25,856 kPa absolute). For example, the pasteurized oat composition 0144 can be post-pasteurization-homogenized 0138 at about 1500 to about 2000 psig (10,342 to 13,790 kPa absolute) and at 60 to 90° C. (e.g., 70 to 90° C., or 75 to 85° C., or 82° C.) to provide the oat composition 0101. In some embodiments, the pasteurized oat composition is post-pasteurization-homogenized 0138 at about 2700 to 3300 psig (18,615 to 22,753 kPa absolute). In some embodiments, the pasteurized oat composition 0144 can be post-pasteurization-homogenized 0138 at about 1500 to 3750 psig (10,342 to 25,856 kPa absolute).

In some embodiments, the oat composition 0101 can be stored 0150 in an aseptic container and at a temperature greater than 0° C. to no more than 6° C.

With reference to FIG. 1, in some embodiments, after the suspension stabilizer 0109 is added to an oat composition 0101, the suspension stabilizer 0109 in the oat composition 0101 is activated (e.g., to increase the viscosity of the oat composition 0101) so that the suspension stabilizer 0109 is effective to maintain the undissolved solids in suspension in the oat composition 0101. As an example, the suspension stabilizer 0109 in an oat composition 0101 can be activated by heat-treatment (e.g., heating 0136) of the oat composition, which can comprise pasteurization. In some embodiments, the heat-treated oat composition 0101 (e.g., the pasteurized oat composition 0144) has a viscosity in cP that is at least 1.5, 2.0, 2.5, 3.0, 3.5 or 4.0 times greater than the viscosity in cP of the oat composition 0101 before heat treatment (e.g., the suspension-stabilized oat slurry 0116, flavored oat slurry, chilled oat slurry 0117, homogenized oat composition 0142, or a combination thereof). Optionally, the heat-treated oat composition 0101 (e.g., the pasteurized oat composition 0144) has a viscosity in cP that is no more than 5.0, 4.5, 4.0, 3.5, 3.0, 2.5, or 2.0 times greater than the viscosity in cP of the oat composition 0101 before heat treatment. The viscosity of the post-heat-treated oat composition can depend on the mass of suspension stabilizer 0109 added to the oat slurry 0107, 0114, 0115 and the resulting mass concentration of the suspension stabilizer 0109 in the oat composition 0101, 0116, 0117, 0142, 0144. The viscosity of the heat-treated oat composition 0101 and the viscosity of the oat composition 0101 before heat treatment can be measured at 8° C. and at a shear rate of 50/s. If a suspension stabilizer were used that did not require activation after being added to the oat slurry, then the viscosities for the heat-treated oat composition 0101 can also apply to the suspension-stabilized oat slurry 0116, flavored oat slurry, chilled oat slurry 0117, homogenized oat composition 0142, or a combination thereof without any subsequent activation (e.g., heat treatment).

### Example 1

An illustrative method and composition of the present disclosure is set forth below. Table 2 contains an exemplary composition of hydrolyzed whole grain oats used in the illustrative method. Table 3 contains an exemplary oat composition that is unsweetened, and Table 4 contains an exemplary oat composition that is sweetened.

As a first step, the starting whole grain oats and enzyme (e.g., α-amylase) can be mixed in any suitable vessel, for example, a high-speed mixer that permits liquid to be added to free-flowing flour. In some embodiments, the suitable vessel is called a preconditioner. The output is a free-flowing starting composition having a water moisture content of about 25 to about 40%. The residence time is the time sufficient to obtain the desired result and typically 1 to 5 min.

As a second step, the free-flowing starting composition can be added to an extruder (e.g., a continuous cooker comprising an extruder) to gelatinize, hydrolyze, and cook the starch. The material can be heated from an initial inlet temperature to a final exit temperature in order to provide the energy for starch gelatinization. Given starting whole grain oats for which the conversion of starch to non-starch components is undesirable (e.g., a whole grain), the starting composition can reside in the extruder for a time sufficient to gelatinize and cook the starch in the flour mixture, but not long enough to substantially dextrinize or otherwise modify the starch to void the whole grain aspect of a whole grain material, for example, at least 30 seconds or at least 1 minute, about 30 seconds to about 1.5 minutes or about 1 to about 1.5 minutes, to form a dough.

Starch gelatinization requires adequate water and energy (e.g., heat). As an example, the gelatinization temperature range for grains (e.g., oats, barley, wheat, etc.) is 127° F. to 160° F. (53-71° C.), or 127° F. to 138° F. (53-59° C.). If the water moisture content is less than about 60% then higher temperatures can be required, as illustrated by the higher temperatures used below in conjunction with a water moisture content of about 25 to 40 wt. %. Additionally, it is worthwhile to note that in some embodiments, if the water moisture content is above about 40 or 50 wt. %, an enzyme-catalyzed hydrolysis reaction that hydrolyzes starch can proceed so quickly that closely controlling it can be useful if the significant conversion of starch to non-starch components is undesirable or if the maintenance of a whole grain status or some other health benefit or claim is desired.

Heat can be applied through the extruder barrel wall such as with a jacket around the barrel through which a hot medium like steam, water or oil is circulated, or electric heaters imbedded in the barrel. Typically the extrusion occurs at barrel temperatures between 140° F. (60° C.) and 350° F. (176.67° C.), for example between 175° F. (79.44° C.) and 340° F. (171.11° C.), about 180° F. (82.22° C.)-300° F. (148.89° C.), or about 270° F. (132.22° C.) to about 310° F. (154.44°), or about 290° F. (143.33° C.). In some embodiments, the extrusion occurs at barrel temperatures between 140° F. (60° C.) and 300° F. (148.89° C.), or between 140° F. (60° C.) and 250° F. (121.11° C.). For example, in one embodiment, the wall temperature of the extruder barrel at the end of the extruder is about 280° F. (137.78° C.) to 300° F. (148.89° C.), or about 290° F. (143.33° C.), which can be useful to ensure that a hydrolysis-catalyzing enzyme is deactivated. Although, after reading this disclosure, a person skilled in the art would recognize that enzymes (e.g., α-amylase, amylases or cellulases) can be deactivated at different temperatures depending on which type of amylase or cellulase is used. Additionally, in some embodiments, the dough (e.g., in the extruder) is provided at a temperature that is approximately between 212° F. (100° C.) and 260° F. (126.67° C.).

Heat is also generated within the material by friction as it moves within the extruder by the dissipation of mechanical energy in the extruder, which is equal to the product of the viscosity and the shear rate squared for a Newtonian fluid. Shear is controlled by the design of the extruder screw(s) and the screw speed. Viscosity is a function of starch structure, temperature, water moisture content, fat content and shear. The temperature of the dough increases in the extruder to about 212° F. (100° C.) to 350° F. (176.67° C.) or about 212° F. (100° C.) to 300° F. (148.89° C.). Although, in some embodiments, the dough temperatures are approximately between 212° F. (100° C.) and 260° F. (126.67° C.).

Extrusion conditions are chosen to adequately heat the extrudate to the desired temperature at the desired water moisture content. Excessive cooked flavor (e.g., cooked grain flavor) can be generated if the combination of time and temperature of the extrudate exceeds an optimum combination of time and temperature. For some embodiments the water moisture content of the extrudate is about 28% to about 33% with a wall temperature after the final barrel section is about 280° F. (137.78° C.) to about 330° F. (165.56° C.) or about 280° F. (137.78° C.) to about 305° F. (151.67° C.). Inadequate water addition can result in dextrinization of the starch in the extrudate. For example, in one embodiment, low shear is applied to the mixture in the extruder. In some embodiments (e.g., where the enzyme has preconditioned the starch), high shear is not required. Additionally, in some embodiments, high shear makes it difficult to control the degree of hydrolysis. It can also increase the dough temperature excessively, which can overcook it resulting in too much cooked flavor. As another example, high shear can dextrinize the starch, which can be undesirable in some embodiments. It is noted that the barrel temperature and the dough temperature can be different.

In some embodiments, the process balances limiting the dough temperature to avoid too much cooked flavor and to keep the enzyme active. For example, the process can be balanced such that the dough temperature rises to a sufficient temperature to deactivate the enzyme after a desired amount of hydrolysis has occurred. Depending on the enzyme used, sufficient temperatures to deactivate the enzyme can be generally 212° F. (100° C.) to about 330° F. (165.56° C.), or about 212° F. (100° C.) to 300° F. (148.89° C.), and/or at least 280° F. (137.78° C.). A low shear extrusion process is characterized relative to a high shear extrusion process by higher moisture and a lower shear screw design versus lower moisture and a higher shear screw design.

Any suitable extruder can be used, including suitable single screw or twin-screw extruders. Typical, but not limiting, screw speeds are 200-350 rpm (e.g., 200-300 rpm).

The resulting product can be pelletized using a forming extruder and dried, for example, to about 1.5 to about 12%, about 1.5 to about 10%, or 6.5 to 8.5% water moisture by weight. The pellets can be granulated to a limited extent so that no more than 5 wt. % (i.e., 0 to 5 wt. %) of the granulated pellets pass through a US 40 screen. In some embodiments, the particle size distribution of the resulting granulated product or flour can be about 1-500 micrometers, about 10-500 micrometers, about 1-450 micrometers, or about 30-420 micrometers. Although, in some embodiments, the pellets are granulated to a limited extent so that no more than 85 wt. % (i.e., 0 to 85 wt. %) of the particles pass through a US 30 screen. Additionally, in some embodiments, filters and/or screen can be used so that 90 to 100 wt. % of particles pass through a 500, 450 or 420 micrometer filter or screen and optionally are retained by a nominal 1, 10 or 30 micrometer filter or screen.

Jet milling can be used to mill the pellets produced in accordance with aspects of the present disclosure. Jet milling creates ultrafine particles. In particular, jet milling can reduce the particle size of all or much of (e.g., 90 to 100 wt. % of) pelletized hydrolyzed flour (e.g., a flour comprising a hydrolyzed product composition) to less than or equal to about 90 micrometers, about 50 micrometers, or about 46 micrometers and greater than 0 micrometers. As one of ordinary skill in the art would recognize, alternative milling processes can be used to reduce the particle size or micrometerize the flour to 0.5-50 micrometers, such as between 10 to 50 micrometers. For example, a milling process can be used to reduce the particle size of the flour so that 90 to 100 wt. % of the flour passes through a nominal 90, 50, or 46 micrometer filter or screen and optionally is retained by a nominal 0.5, 1, or 10 micrometer filter or screen.

The resulting hydrolyzed product composition (e.g., hydrolyzed size-reduced product composition, hydrolyzed whole grain oats) can include beta-glucan soluble fiber, such as beta-1,3-glucan, beta-1,6-glucan, or beta-1,4-glucan or mixtures thereof. In addition to beta-glucan naturally present in the hydrolyzed whole grain oats, beta-glucan can also be added as approved by the FDA. In certain embodiments, the hydrolyzed product composition (e.g., hydrolyzed size-reduced product composition, hydrolyzed whole grain oats) preferably contains at least about 3%, at least about 4%, or about 3% to 5% or about 3.7% to 4% beta-glucan on a dry weight basis. In certain embodiments, a product including the hydrolyzed product composition (e.g., oat flour) contains 0.1% to about 1.5% beta-glucan, or about 0.8% to 1.3% beta-glucan. Other amounts of beta-glucan are also useful. Additionally, in some embodiments, the hydrolyzed product composition (e.g., hydrolyzed size-reduced product composition, hydrolyzed whole grain oats) can contain at least about 6%, 7%, 8%, 9%, or 10% or about 8% to about 12% total dietary fiber by weight. Furthermore, for example, in accordance with the most recent effective version of 21 CFR 101.81, a whole oat flour can be produced from 100 percent dehulled, clean oat groats by steaming and grinding, such that there is no significant loss of oat bran in the final flour. Table 1 below shows an exemplary composition of the starting whole oat grain oats that can be used prior to hydrolysis.

TABLE 1
Starting Whole Gain Oats
Starting Whole Grain Oats

| Component | wt. % |
|---|---|
| Oat Flour | 100 |
| Beta-glucan | 3.35 |
| Fat | 7.51 |
| Water moisture | 7.69 |
| Protein | 12.76 |
| Starch | 55.75 |
| Sugar | 1.01 |
| Fiber | 9.03 |

The hydrolyzed product composition (e.g., hydrolyzed size-reduced product composition, hydrolyzed oats, or hydrolyzed whole grain oats) made using the method described above is summarized in Table 2 shown below. The oat flour component prior to hydrolysis of the hydrolyzed whole grain oats is summarized in Table 1.

TABLE 2
Hydrolyzed Whole Gain Oats
Hydrolyzed Whole Grain Oats

| Component | wt. % |
|---|---|
| Oat Flour | 98.803 |
| Tocopherols | 0.499 |
| Calcium Silicate | 0.499 |
| Alpha-Amylase Enzyme | 0.199 |
| Beta-glucan | 3.49 |
| Fat | 7.63 |
| Water moisture | 8.12 |
| Protein | 12.81 |
| Starch | 53.01 |
| Sugar | 0.96 |
| Fiber | 9.33 |

The hydrolyzed product composition (e.g., hydrolyzed size-reduced product composition, hydrolyzed oats, or hydrolyzed whole grain oats), for which an example is provided in Table 2, can be used in a method for making an oat composition of the present disclosure.

As an example, the hydrolyzed product composition (e.g., hydrolyzed size-reduced product composition, hydrolyzed whole grain oats) tricalcium phosphate, salt (e.g., NaCl, sea salt, table salt, or a combination thereof), and water are combined to provide a combination (which is an example of an oat slurry 0107) and the combination is agitated with a high shear mixer for about 30 minutes at a temperature of about 130 to 150° F. (54° C. to 66° C.) in a liquefier to provide a mixture (which is an example of an oat slurry 0107). A salt or the plurality of salts (e.g., tricalcium phosphate, NaCl, etc.) can be used to provide a nutrient (e.g., calcium), to help stabilize the pH of the beverage (e.g., to act as a pH buffer), or a combination thereof. The mass of the water added is sufficient to provide the mixture with an undissolved solids content that is no more than 10% by weight. Next, the mixture, inulin, optional sweetener, emulsifier (e.g., gum acacia), sunflower oil and additional water are combined and mixed to provide an emulsion-stabilized oat slurry 0114. The mass of the additional water is sufficient to provide a water content equal to at least 90% by weight or a total solids content (i.e. the sum of undissolved solids and dissolved solids) equal to no more than 10% by weight in the emulsion-stabilized oat slurry 0114. The emulsion-stabilized oat slurry is circulated in a high shear mixer for 10 minutes and then is cooled to less than 95° F. (35° C.) with a heat exchanger to provide a cooled oat slurry 0115. Suspension stabilizer (e.g., gellan gum, high methoxy gellan gum, high acyl gellan gum, HM-B gellan gum, or a composition comprising both MCC and CMC), vitamin premix, and additional flavors are added to the cooled oat slurry 0115 and mixed with a high shear mixer for about 5 minutes to provide a suspension-stabilized oat slurry 0116, which is also a flavored oat slurry. The suspension-stabilized oat slurry 0116 (e.g., flavored oat slurry) is an example of an oat composition 0101. Adding the suspension stabilizer to a cooled oat slurry (e.g. an oat slurry at a temperature less than 113° F. (45° C.), 110° F. (43.3° C.), 100 F (37.8 C), or 95 F (35 C), can be useful to avoid activating the suspension stabilizer (which can be heat-activated) and, for example, thereby increasing the viscosity of the resulting suspension-stabilized slurry 0116 (e.g., flavored oat slurry) and potentially complicating the processing of the slurry. In some embodiments, the suspension is cooled to more than about 42.8° F. (6° C.), 50° F. (10° C.), 59° F. (15° C.) or 68° F. (20° C.) to provide a cooled oat slurry. The suspension-stabilized oat slurry 0116 (e.g., flavored oat slurry) can also be cooled to a temperature of 2 to 6° C. to provide a chilled oat slurry 0117, which is another example of an oat composition 0101. Once the suspension-stabilized oat slurry (e.g., flavored oat slurry) is cooled, it can be transferred for pasteurization, for example, using Ultra High Temperature (UHT) processing, to provide another example of an oat composition 0101. Tables 2 and 3 show two examples of finished oat compositions.

TABLE 3
Unsweetened Oat Composition
Unsweetened Oat Composition

| Component | wt. % |
|---|---|
| Hydrolyzed whole grain oats | 3.400 |
| Inulin | 1.050 |
| Vegetable Oil | 0.750 |
| Tri calcium phosphate | 0.309 |
| Gum Acacia/Gum Arabic | 0.200 |
| Purified sea salt | 0.070 |
| Natural flavors | 0.300 |
| Gellan gum | 0.025 |
| Vitamin Premix | 0.0042 |
| Water | 93.892 |

Table 3 is an unsweetened embodiment with a total solids content of about 5.7 wt. % and a pH of about 7.1.

TABLE 4
Sweetened Oat Composition
Sweetened Oat Composition

| Component | wt. % |
|---|---|
| Hydrolyzed whole grain oats | 3.400 |
| Sugar | 2.800 |
| Inulin | 1.050 |
| Vegetable oil | 0.750 |
| Tri calcium phosphate | 0.309 |
| Gum Acacia/Gum Arabic | 0.200 |
| Purified sea salt | 0.100 |
| Flavors | 0.150 |
| High Methoxy Gellan Gum | 0.025 |
| Vitamin Premix | 0.0042 |
| Water | 91.212 |

Table 4 is a sweetened embodiment with a total solids content of about 8.6 wt. % and a pH of 7.1.

Furthermore, the following two tables show an exemplary composition of the starting whole oat grain oats that can be used prior to hydrolysis and an exemplary hydrolyzed product composition.

TABLE 5
Starting Whole Gain Oats
Starting Whole Grain Oats

| Component | wt. % |
|---|---|
| Oat Flour | 100 |
| Beta-glucan | 3.66 |
| Fat | 7.99 |
| Water moisture | 8.51 |
| Protein | 12.82 |
| Starch | 54.99 |
| Sugar | 2.45 |
| Fiber | 6.8 |

TABLE 6
Hydrolyzed Whole Gain Oats
Hydrolyzed Whole Grain Oats

| Component | wt. % |
|---|---|
| Oat Flour | 98.803 |
| Tocopherols | 0.499 |
| Calcium Silicate | 0.499 |
| Alpha-Amylase Enzyme | 0.199 |
| Beta-glucan | 4.03 |
| Fat | 7.18 |
| Water moisture | 8.98 |
| Protein | 12.75 |
| Starch | 52.63 |
| Sugar | 1.1 |
| Fiber | 9.88 |

In some embodiments of the composition comprising a hydrolyzed product composition 0112 or hydrolyzed oats, the hydrolyzed oats can be in the form of oats (e.g., non-whole grain oats) or oat flour (e.g., non-whole grain oat flour) as an alternative to whole grain oats or whole grain oat flour. In other words, although several embodiments are described herein with reference to hydrolyzed whole grain oats or a hydrolyzed product composition 0112 comprising hydrolyzed whole grain oats, the hydrolyzed whole grain oats can be hydrolyzed oats (e.g., hydrolyzed non-whole grain oats or hydrolyzed non-whole grain oat flour), which can be made from starting oats (e.g., starting non-whole grain oats or starting non-whole grain oat flour).

Further examples of, methods for making or using, systems for making or using, or apparatuses for making or using hydrolyzed oats, hydrolyzed whole grain oats 0104, size-reduced hydrolyzed oats, size-reduced hydrolyzed whole grain oats 0105, hydrolyzed product compositions 0112 comprising hydrolyzed oats, and hydrolyzed product compositions 0112 comprising hydrolyzed whole grain oats 0104, hydrolyzed product compositions 0112 comprising size-reduced hydrolyzed oats, hydrolyzed product compositions 0112 comprising size-reduced hydrolyzed whole grain oats 0105, or a combination thereof will now be described with reference to several documents, all of which are incorporated herein by reference in their entirety as examples for making or using hydrolyzed oats, hydrolyzed whole grain oats 0104, hydrolyzed product compositions 0112 comprising hydrolyzed oats, hydrolyzed product compositions 0112 comprising hydrolyzed whole grain oats 0104, or a combination thereof. As a first example, U.S. patent application Ser. No. 12/056,598, entitled “Hydrolyzed, Spray Dried, Agglomerated Grain Powder and Drinkable Food Products,” was published as U.S. Patent Application Publication No. 2008/0260909 A1 and issued as U.S. Pat. No. 8,241,696, which are all hereby incorporated by reference in their entirety as examples. In one aspect, U.S. Pat. No. 8,241,696 includes or can be modified to include a drinkable food product comprising water and about 5 wt. % to about 15 wt. % hydrolyzed, spray-dried, agglomerated oat powder by weight of the total drinkable food product. In some embodiments, the agglomerated oat powder has an average particle size of 150 to 450 m. In some embodiments, at least 70% of the particles are within the range of 150 to 450 m.

In a second aspect, U.S. Pat. No. 8,241,696 includes or can be modified to include a drinkable food product comprising milk and about 5 wt. % to about 15 wt. % hydrolyzed, spray-dried, agglomerated oat powder by weight of the total drinkable food product. In some embodiments, the agglomerated oat powder has an average particle size of 150 to 450 μm. In some embodiments, at least 70% of the particles are within the range of 150 to 450 μm.

In a third aspect, U.S. Pat. No. 8,241,696 includes or can be modified to include a drinkable oatmeal product comprising about 5 wt. % to about 15 wt. % hydrolyzed agglomerated oat flour by weight of the total drinkable food product; water; and a fruit component selected from the group consisting of fruit juice, yogurt containing fruit, fruit puree, fresh fruit, dried fruit powder, fruit preserves and combinations thereof. In some embodiments, the agglomerated oat powder has an average particle size of 150 to 450 μm. In some embodiments, at least 70% of the particles are within the range of 150 to 450 m.

In a fourth aspect, U.S. Pat. No. 8,241,696 includes or can be modified to include a method of improving dispersibility of oat powder in a beverage, comprising the steps of mixing about 5 wt. % to about 15 wt. % hydrolyzed, spray-dried, agglomerated oat powder with a liquid. In some embodiments, the agglomerated oat powder has an average particle size of 150 to 450 μm. In some embodiments, at least 70% of the particles are within the range of 150 to 450 μm.

U.S. patent application Ser. No. 12/264,399, entitled “Soluble Oat Flour and Method of Making Utilizing Enzymes,” was published as U.S. Patent Application Publication No. 2010/0112127 A1 and issued as U.S. Pat. No. 8,574,644, which are all hereby incorporated by reference in their entirety as examples. In one aspect, U.S. Pat. No. 8,574,644 includes or can be modified to include a method of producing a whole oat flour having soluble fiber comprising one or more steps selected from the following list of steps. A first step comprises combining a whole oat flour starting mixture and an α-amylase enzyme water solution to form a wetted enzyme starting mixture having a water moisture content of about 25 to about 40 wt. %. A second step comprises heating the wetted enzyme starting mixture to between about 120° F. and about 200° F. A third step comprises adding the heated wetted mixture to an extender and extending for 1 to 1.5 minutes at a barrel temperature of about 140° F. to about 250° F. to form the whole oat flour having soluble fiber. In some embodiments, the temperature of the mixture increases in the extender to a temperature to deactivate the enzyme.

In a second aspect, U.S. Pat. No. 8,574,644 includes or can be modified to include a method for preparing a beverage containing a whole oat flour having soluble fiber comprising one or more steps selected from the following list of steps. A first step comprises combining a whole oat flour starting mixture and an α-amylase enzyme water solution to form wetted enzyme starting mixture having a water moisture content of about 25 to about 40 wt. %. A second step comprises heating the wetted enzyme starting mixture to between about 120° F. and about 200° F. A third step comprises adding the heated wetted mixture to an extruder and extruding for 1 to 1.5 minutes at a barrel temperature of about 140° F. to about 250° F. to form the whole oat flour having soluble fiber. A fourth step comprises adding the whole oat flour having soluble fiber to a beverage. In some embodiments, the temperature of the mixture increases in the extruder to a temperature to deactivate the enzyme.

In a third aspect, U.S. Pat. No. 8,574,644 includes or can be modified to include a method for preparing a food product containing a whole oat flour having soluble fiber comprising one or more steps selected from the following list of steps. A first step comprises combining a whole oat flour starting mixture and an α-amylase enzyme water solution to form a wetted enzyme starting mixture having a water moisture content of about 25 to about 40 wt. %. A second step comprises heating the wetted enzyme starting mixture to between about 120° F. and about 200° F. A third step comprises adding the heated wetted mixture to an extruder and extruding for 1 to 1.5 minutes at a barrel temperature of about 140° F. to about 250° F. to form the whole oat flour having soluble fiber. A fourth step comprises adding the whole oat flour having soluble fiber to a mixture for a food product. In some embodiments, the temperature of the mixture increases in the extruder to a temperature to deactivate the enzyme.

U.S. patent application Ser. No. 12/264,404, entitled “Soluble Oat or Barley Flour and Method of Making Utilizing a Continuous Cooker,” was published as U.S. Patent Application Publication No. 2010/0112167 A1 and issued as U.S. Pat. No. 8,802,177, which are all hereby incorporated by reference in their entirety as examples. In one aspect, U.S. Pat. No. 8,802,177 includes or can be modified to include a method of producing a soluble whole oat or barley flour comprising one or more steps selected from the following list of steps. A first step comprises hydrating and heating to 140° F.-160° F. a whole oat or barley flour starting mixture to form a uniform free flowing wetted material having a water moisture level of about 28 to about 30% by weight. In some embodiments, the whole oat or barley flour starting mixture comprises about 80 to about 95% by weight whole oat or barley flour, sugar, and at least one antioxidant. A second step comprises adding the hydrated whole oat or barley flour starting mixture to a low-shear extruder. In some embodiments, the extruder barrel temperature of about 140° F. to about 250° F. A third step comprises extruding the whole oat or barley flour starting mixture at a screw speed of 200 to 300 rpm to obtain a dough having a temperature of 212° F.-260° F. and to gelatinize and dextrinize the dough within the extruder. A fourth step comprises granulating the dough exiting the extruder to form the soluble whole oat or barley flour having a particle size of 50 to 250 micrometers.

In a second aspect, U.S. Pat. No. 8,802,177 includes or can be modified to include a method for preparing a beverage containing a soluble whole oat or barley flour comprising one or more steps selected from the following list of steps. A first step comprises hydrating and heating to 140° F.-160° F. a whole oat or barley flour starting mixture to form a uniform free flowing wetted material having a moisture level of about 28 to about 30% by weight. In some embodiments, the whole oat or barley flour starting mixture comprises about 80 to about 95% by weight whole oat or barley flour, sugar, and at least one antioxidant. A second step comprises adding the hydrated whole oat or barley flour starting mixture to a low-shear extruder. In some embodiments, the extruder barrel temperature of about 140° F. to about 250° F. A third step comprises extruding the whole oat or barley flour starting mixture and heat at a screw speed of 200 to 300 rpm to obtain a dough having a temperature of 212° F.-260° F., and to gelatinize and dextrinize the dough within the extruder. A fourth step comprises granulating the dough exiting the extruder to form the soluble oat or barley flour having a particle size of 50 to 250 micrometers. A fifth step comprises adding the soluble whole oat or barley flour to a beverage. In some embodiments, the soluble flour is added to provide a beverage having 1 to 25% by weight soluble fiber based on total weight of the beverage.

U.S. patent application Ser. No. 12/814,610, entitled “Method of Preparing Highly Dispersible Whole Grain Flour,” was published as U.S. Patent Application Publication No. 2010/0316765 A1 and issued as U.S. Pat. No. 8,586,113, which are all hereby incorporated by reference in their entirety as examples. In one aspect, U.S. Pat. No. 8,586,113 includes or can be modified to include a method of preparing a highly dispersible whole grain flour comprising one or more steps selected from the following list of steps. A first step comprises hydrolyzing a whole grain flour using alpha-amylase, the alpha-amylase hydrolyzes the whole grain flour while maintaining the integrity of the whole grain; and then optionally heating the hydrolyzed whole grain flour to a temperature to deactivate the alpha-amylase. A second step comprises finely milling the hydrolyzed whole grain flour to a particle size of about 50-200 micrometers. A third step comprises agglomerating the whole grain flour.

In a second aspect, U.S. Pat. No. 8,586,113 includes or can be modified to include a method of preparing a highly dispersible whole grain flour comprising one or more steps selected from the following list of steps. A first step comprises combining a whole grain flour starting mixture and alpha-amylase to form an enzyme starting mixture. In some embodiments, the alpha-amylase hydrolyzes the whole grain flour while maintaining the integrity of the whole grain. A second step comprises introducing the enzyme starting mixture to an extruder. A third step comprises gelatinizing the whole grain flour by mechanical action and heating the extruder to form hydrolyzed whole grain flour dough, and optionally increasing the temperature of the dough in the extruder to a temperature to deactivate the enzyme. A fourth step comprises pelletizing the hydrolyzed whole grain flour dough to form hydrolyzed whole grain pellets. A fifth step comprises finely milling the hydrolyzed whole grain pellets to form hydrolyzed whole grain particles having a particle size of about 50-200 micrometers. A sixth step comprises agglomerating the hydrolyzed whole grain particles to form highly dispersible hydrolyzed whole grain flour.

U.S. patent application Ser. No. 12/666,509, entitled “Soluble Oat Flour and Method of Making Utilizing Enzymes,” was published as U.S. Patent Application Publication No. 2011/0189341 A1 and issued as U.S. Pat. No. 8,591,970, which are all hereby incorporated by reference in their entirety as examples. In one aspect, U.S. Pat. No. 8,591,970 is directed to a beverage containing a soluble whole oat flour. In some embodiments, the soluble whole oat flour is prepared by a method comprising one or more steps selected from the following list of steps. A first step comprises combining a whole oat flour starting mixture and an α-amylase enzyme water solution to form a wetted enzyme starting mixture having a water moisture content of about 25 to about 40 wt. %. A second step comprises heating the wetted enzyme starting mixture to between about 120° F. and about 200° F. A third step comprises adding the heated wetted mixture to an extruder and extruding for 1 to 1.5 minutes and to form the soluble whole oat flour. In some embodiments, the temperature of the mixture increases in the extruder to a temperature to deactivate the enzyme.

U.S. patent application Ser. No. 12/666,506, entitled “Soluble Oat or Barley Flour and Method of Making Utilizing a Continuous Cooker,” was published as U.S. Patent Application Publication No. 2011/0281007 A1 and issued as U.S. Pat. No. 8,795,754, which are all hereby incorporated by reference in their entirety as examples. In one aspect, U.S. Pat. No. 8,795,754 includes or can be modified to include beverage comprising soluble whole oat or barley flour. In some embodiments, the beverage is prepared by a method comprising one or more steps selected from the following list of steps. A first step comprises hydrating and heating to 140° F.-160° F. a whole oat or barley flour starting mixture to form a uniform free flowing material having a water moisture level of about 28 to about 30% by weight. In some embodiments, the whole oat or barley flour starting mixture comprises about 80 to about 95% by weight whole oat or barley flour, sugar, and at least one antioxidant. A second step comprises adding the hydrated whole oat or barley flour starting mixture to a low-shear extruder having an extruder barrel temperature of about 140° F. to about 250° F. A third step comprises extruding the whole oat or barley flour starting mixture at a screw speed of 200 to 300 rpm to obtain a dough having a temperature of 212° F.-260° F., and to gelatinize and dextrinize the dough within the extruder. A fourth step comprises granulating the dough exiting the extruder to form the soluble whole oat or barley flour having a particle size of 50 to 250 micrometers. A fifth step comprises adding the soluble whole oat or barley flour to a beverage to provide a beverage having 1 to 25% by weight soluble fiber based on total weight of the beverage.

U.S. patent application Ser. No. 13/547,733, entitled “Method of Preparing an Oat-Containing Dairy Beverage,” was published as U.S. Patent Application Publication No. 2013/0017300 A1 which are all hereby incorporated by reference in their entirety as examples. In one aspect, U.S. Patent Application Publication No. 2013/0017300 A1 includes or can be modified to include a ready-to-drink milk-based oat beverage comprising: a. hydrolyzed oat flour; b. fluid milk; c. at least one nutritive or non-nutritive sweetener; d. at least one stabilizer; e. at least one salt; and f. a combination thereof. In some embodiment, the beverage has a shelf life of about 6 months at 25° C.

In a second aspect, U.S. Patent Application Publication No. 2013/0017300 A1 includes or can be modified to include a method for preparing an oat containing beverage comprising one or more steps selected from the following steps. A first step comprises hydrating hydrolyzed oat flour under ambient conditions or chilled conditions. A second step comprises introducing the hydrolyzed oat flour to chilled fluid milk at a temperature of about 4-7° C. to form a raw beverage. A third step comprises maintaining the raw beverage at a temperature of 4-7° C. A fourth step comprises preheating the raw beverage to 80° C. prior to homogenization. A fifth step comprises homogenizing the raw beverage to form a final beverage. A sixth step comprises introducing the final beverage to sterilization at a temperature of about 140-145° C.

In a third aspect, U.S. Patent Application Publication No. 2013/0017300 A1 includes or can be modified to include a system for preparing an oat containing beverage comprising several components selected from the group consisting of: a. an agitated vessel for hydrating hydrolyzed oat flour under ambient conditions; b. a vessel for storing chilled fluid milk at a temperature of about 4-7° C.; c. a mixer/disperser to mix the chilled fluid milk and hydrated hydrolyzed oat flour to form a raw beverage; d. a preheater to preheat the raw beverage; e. a homogenizer to form a final beverage from the raw beverage; f. an aseptic sterilizer to form a final sterilized beverage from the final beverage, g. an aseptic filler/packaging to finalize shelf stable product ready to drink; and h. a combination thereof.

U.S. patent application Ser. No. 13/784,255, entitled “Method of Processing Oats to Achieve Oats with an Increased Avenanthramide Content,” was published as U.S. Patent Application Publication No. 2013/0183405 A1 and issued as U.S. Pat. No. 9,504,272, which are all hereby incorporated by reference in their entirety as examples. In one aspect, U.S. Pat. No. 9,504,272 includes or can be modified to include a composition comprising whole grain oat flour. In some embodiments, the whole grain oat flour meets the standard of identity for whole grain, the composition disperses in less than about 5 seconds in a liquid media at 25° C., the whole grain oat flour contains about 20-35% more avenanthramides on a weight basis compared to native whole grain oat flour, or a combination thereof.

In a second aspect, U.S. Pat. No. 9,504,272 includes or can be modified to include a composition comprising whole grain oat flour. In some embodiments, the whole grain oat flour contains about 20-35% more avenanthramides on a weight basis compared to native whole grain oat flour.

In a third aspect, U.S. Pat. No. 9,504,272 includes or can be modified to include a composition produced using a process comprising one or more steps selected from the following list of steps. A first step comprises combining a whole grain oat flour starting mixture with an aqueous enzyme solution to form an enzyme starting mixture having a water moisture content of 25 to 40 wt. %. A second step comprises heating the enzyme starting mixture to between about 120° F. and 200° F. A third step comprises adding the heated starting mixture to an extruder and extruding the mixture until the temperature of the mixture increases to about 260° F. to 300° F. In some embodiments, the enzyme is deactivated to form the composition, the composition comprises whole grain oat flour, the whole grain oat flour maintains its standard of identity throughout processing, the composition disperses in less than about 5 seconds in a liquid media at 25° C., the whole grain oat flour contains at least 20% higher level of avenanthramides on a weight basis compared to native whole grain oat flour, or a combination thereof.

U.S. patent application Ser. No. 13/833,717, entitled “Method of Preparing Highly Dispersible Whole Grain Flour with an Increased Avenanthramide Content,” was published as U.S. Patent Application Publication No. 2013/0209610 A1 and issued as U.S. Pat. No. 9,011,947, which are all hereby incorporated by reference in their entirety as examples. In one aspect, U.S. Pat. No. 9,011,947 includes or can be modified to include a highly dispersible whole grain oat flour containing about 20-35% more avenanthramides compared to native whole oat flour. In some embodiments, the whole grain oat flour is agglomerated following hydrolysis, pelletizing and milling.

In a second aspect, U.S. Pat. No. 9,011,947 includes or can be modified to include a highly dispersible whole grain oat flour produced using a process comprising one or more steps selected from the following list of steps. A first step comprises combining a native whole grain oat flour starting mixture with an aqueous enzyme solution to form an enzyme starting mixture having a water moisture content of 25 to 40 wt. %. A second step comprises heating the enzyme starting mixture. A third step comprises adding the heated starting mixture to an extruder and extruding the mixture until the temperature of the mixture increases to about 260° F. to 300° F. In some embodiments, the enzyme is deactivated. A fourth step comprises pelletizing the extruded flour. A fifth step comprises drying the pelletized extruded flour. A sixth step comprises milling the pelletized extruded flour to a particle size of about 50-420 micrometers. A seventh step comprises agglomerating the milled extruded flour to a particle size of about 150-1000 micrometers. In some embodiments, the highly dispersible whole grain oat flour contains at least 20% higher level of avenanthramides compared to native whole oat flour.

U.S. patent application Ser. No. 14/059,566, entitled “Soluble Oat Flour and Method of Making Utilizing Enzymes,” was published as U.S. Patent Application Publication No. 2014/0050819 A1 and issued as U.S. Pat. No. 9,149,060, which are all hereby incorporated by reference in their entirety as examples. In one aspect, U.S. Pat. No. 9,149,060 includes or can be modified to include a method of producing a whole oat flour having soluble fiber. In some embodiments, the method comprises one or more steps selected from the following list of steps. A first step comprises forming a whole oat flour starting mixture comprising about 50 to about 100% whole oat flour, 0 to about 15% granulated sugar, and 0 to about 15% maltodextrin. A second step comprises combining the whole oat flour starting mixture and an α-amylase enzyme water solution to form a wetted enzyme starting mixture having a water moisture content of about 25 to about 40 wt. %. A third step comprises heating the wetted enzyme starting mixture to between about 120° F. and about 200° F. A fourth step comprises adding the heated wetted mixture to an extruder and extruding for 1 to 1.5 minutes to produce the whole oat flour having soluble fiber. In some embodiments, the temperature of the mixture increases in the extruder to a temperature to deactivate the enzyme.

In a second aspect, U.S. Pat. No. 9,149,060 includes or can be modified to include a method for producing a beverage containing a whole oat flour having soluble fiber. In some embodiments, the method comprises one or more steps selected from the following list of steps. A first step comprises forming a whole oat flour starting mixture comprising about 50 to about 100% whole oat or barley flour, 0 to about 15% granulated sugar, and 0 to about 15% maltodextrin. A second step comprises combining the whole oat flour starting mixture and an α-amylase enzyme water solution to form wetted enzyme starting mixture having a water moisture content of about 25 to about 40 wt. %. A third step comprises heating the wetted enzyme starting mixture to between about 120° F. and about 200° F. A fourth step comprises adding the heated wetted mixture to an extruder and extruding for 1 to 1.5 minutes to form the whole oat flour having soluble fiber. In some embodiments, the temperature of the mixture increases in the extruder to a temperature to deactivate the enzyme. A fifth step comprises adding the whole oat flour having soluble fiber to a beverage.

U.S. patent application Ser. No. 14/209,000, entitled “Food Products Prepared with Soluble Whole Grain Oat Flour,” was published as U.S. Patent Application Publication No. 2014/0193564 A1 and issued as U.S. Pat. No. 9,510,614, which are all hereby incorporated by reference in their entirety as examples. In one aspect, U.S. Pat. No. 9,510,614 includes or can be modified to include a beverage comprising whole grain oat flour. In some embodiments, the whole grain oat flour is highly dispersible in water, the beverage provides ½ to 1 serving of whole grain per 8 oz serving of the beverage, the serving of whole grain is 16 g of whole grain, or a combination thereof. In some embodiments, the whole grain oat flour is produced by a process comprising one or more steps selected from the following list of steps. A first step comprises hydrolyzing starch in the whole grain oat flour in an extruder. In some embodiments, the starch hydrolysis is catalyzed by α-amylase. A second step comprises deactivating the α-amylase in the extruder before the starch hydrolysis results in a substantial change in a mass concentration of sugar in the whole grain oat flour.

In a second aspect, U.S. Pat. No. 9,510,614 includes or can be modified to include a semi-solid dairy product comprising whole grain oat flour in an amount of 2 to 11 wt. % based on total weight of the semi-solid dairy product. In some embodiments, the whole grain oat flour is highly dispersible in water. In some embodiments, the whole grain oat flour is produced by a process comprising one or more steps selected from the following list of steps. A first step comprises hydrolyzing starch in the whole grain oat flour in an extruder. In some embodiments, the starch hydrolysis is catalyzed by α-amylase. A second step comprises deactivating the α-amylase in the extruder before the starch hydrolysis results in a substantial change in a mass concentration of sugar in the whole grain oat flour.

In a third aspect, U.S. Pat. No. 9,510,614 includes or can be modified to include an instant powder for preparing a cold beverage comprising 25 to 60 wt. % whole grain oat flour. In some embodiments, the whole grain oat flour is highly dispersible in water; when the whole grain oat flour is hydrated in liquid to form the beverage, the beverage provides ½ to 1 serving of whole grain per 8 oz serving of the beverage; the serving of whole grain is 16 g of whole grain, or a combination thereof. In some embodiments, the whole grain oat flour is produced by a process comprising one or more steps selected from the following list of steps. A first step comprises hydrolyzing starch in the whole grain oat flour in an extruder. In some embodiments, the starch hydrolysis is catalyzed by α-amylase. A second step comprises deactivating the α-amylase in the extruder before the starch hydrolysis results in a substantial change in a mass concentration of sugar in the whole grain oat flour.

In a fourth aspect, U.S. Pat. No. 9,510,614 includes or can be modified to include an instant powder comprising 25 to 35 wt. % whole grain oat flour. In some embodiments, the whole grain oat flour is highly dispersible in water. In some embodiments, when hydrated in liquid to provide a product, the powder provides ½ to 1 whole serving of whole grain per 4 to 8 oz serving of the product; and/or the serving of whole grain is 16 g of whole grain. In some embodiments, the whole grain oat flour is produced by a process comprising one or more steps selected from the following list of steps. A first step comprises hydrolyzing starch in the whole grain oat flour in an extruder. In some embodiments, the starch hydrolysis is catalyzed by α-amylase. A second step comprises deactivating the α-amylase in the extruder before the starch hydrolysis results in a substantial change in a mass concentration of sugar in the whole grain oat flour.

U.S. patent application Ser. No. 14/209,075, entitled “Food Products Prepared with Soluble Whole Grain Oat Flour,” was published as U.S. Patent Application Publication No. 2014/0193563 A1 and issued as U.S. Pat. No. 9,622,500, which are all hereby incorporated by reference in their entirety as examples. In one aspect, U.S. Pat. No. 9,622,500 includes or can be modified to include a bakery product selected from the group consisting of muffins, cookies, breads, bagels, pizza crust, cakes, crepes, and pancakes. In some embodiments the bakery product is prepared from ingredients comprising whole grain oat flour in an amount of 2 to 10 wt. % as a texturizer. In some embodiments, the whole grain oat flour is highly dispersible in water so that there are no lumps of the whole grain oat flour in a mixture of the whole grain oat flour and water at 25° C. after stirring the mixture for 5 seconds.

U.S. patent application Ser. No. 14/959,941, entitled “Whole Grain Composition Comprising Hydrolyzed Starch,” was published as U.S. Patent Application Publication No. 2016/0081375 A1, which are all hereby incorporated by reference in their entirety as examples. In one aspect, U.S. Patent Application Publication No. 2016/0081375 includes or can be modified to include a composition comprising a whole grain, and the whole grain comprises hydrolyzed starch.

U.S. patent application Ser. No. 15/077,670, entitled “Method, Apparatus, and Product Providing Hydrolyzed Starch and Fiber,” which is hereby incorporated by reference in its entirety as an example. In one aspect, U.S. patent application Ser. No. 15/077,670 includes or can be modified to include a composition comprising at least one material selected from the group consisting of at least a portion of grain and at least a portion of pulse. In some embodiments, the at least one material comprises hydrolyzed starch and hydrolyzed fiber; the hydrolyzed starch consists of starch molecules; the average molecular weight of the hydrolyzed starch molecules in the composition is a first fraction of the molecular weight of unhydrolyzed starch molecules; the unhydrolyzed starch molecules are equivalent in kind and condition to the hydrolyzed starch molecules, except that the unhydrolyzed starch molecules have not been hydrolyzed; the first fraction is no more than about 0.80; the hydrolyzed fiber consists of fiber molecules; the average molecular weight of the hydrolyzed fiber molecules in the composition is a second fraction of the molecular weight of unhydrolyzed fiber molecules; the unhydrolyzed fiber molecules are equivalent in kind and condition to the hydrolyzed fiber molecules, except that the unhydrolyzed fiber molecules have not been hydrolyzed; the second fraction is no more than about 0.80; or a combination thereof.

In a second aspect, U.S. patent application Ser. No. 15/077,670 includes or can be modified to include a method comprising one or more steps selected from the following list of steps. A first step comprises providing starting components comprising a first enzyme; a second enzyme; water; and a starting composition. In some embodiments, the starting composition comprises at least one material selected from the group consisting of at least a portion of grain and at least a portion of pulse. In some embodiments, the at least one material comprises starch and fiber. A second step comprises hydrolyzing the fiber in the at least one material through a fiber hydrolysis reaction. In some embodiments, the fiber hydrolysis reaction is catalyzed by the first enzyme. A third step comprises hydrolyzing the starch in the at least one material through a starch hydrolysis reaction. In some embodiments, the starch hydrolysis reaction is catalyzed by the second enzyme. A fourth step comprises deactivating the first enzyme. A fifth step comprises deactivating the second enzyme. In some embodiments the method provides a product composition.

U.S. patent application Ser. No. 15/077,676, entitled “Method and Apparatus for Controlled Hydrolysis,” which is hereby incorporated by reference in its entirety as an example. In one aspect, U.S. patent application Ser. No. 15/077,676 includes or can be modified to include a method comprising one or more steps selected from the following list of steps. A first step comprises hydrolyzing a first reagent in a first hydrolysis reaction. A second step comprises deactivating a first enzyme catalyzing the first hydrolysis reaction. In some embodiments, the deactivating step lasts no more than about 10 seconds.

In a second aspect, U.S. patent application Ser. No. 15/077,670 includes or can be modified to include a hydrolysis reactor comprising a conduit; a composition inlet in the conduit for a composition; a first enzyme inlet in the conduit downstream of the composition inlet; a first deactivating mechanism downstream of the first enzyme inlet to deactivate the first enzyme; or a combination thereof.

U.S. patent application Ser. No. 15/077,75800, entitled “Method and Composition Comprising Hydrolyzed Starch,” was published as U.S. Patent Application Publication No. 2016/0198754 A1, which are all hereby incorporated by reference in their entirety as examples. In one aspect, U.S. Patent Publication No. 2016/0198754 A1 includes or can be modified to include a method comprising one or more steps selected from the following list of steps. A first step comprises combining at least a portion of pulse and a suitable enzyme to form an enzyme-pulse starting mixture. In some embodiments, the enzyme-pulse starting mixture comprises starch. A second step comprises heating the enzyme-pulse starting mixture to between about 48.89° C. and about 93.33° C. to begin to hydrolyze the starch, thereby providing a heated pulse mixture. A third step comprises extruding the heated pulse mixture to continue hydrolyzing the starch and further to gelatinize and cook the heated pulse mixture thereby providing a pulse product comprising gelatinized, hydrolyzed starch.

In a second aspect, U.S. Patent Publication No. 2016/0198754 A1 includes or can be modified to include a composition comprising at least a portion of pulse, and the at least a portion of pulse comprises gelatinized, hydrolyzed starch.

In a third aspect, U.S. Patent Publication No. 2016/0198754 A1 includes or can be modified to include a composition comprising whole grain, and the whole grain comprises gelatinized, hydrolyzed starch.

U.S. patent application Ser. No. 15/481,286, entitled “Food Products Prepared with Soluble Whole Grain Oat Flour,” which is hereby incorporated by reference in its entirety as an example. In one aspect, U.S. patent application Ser. No. 15/481,286 includes or can be modified to include instant oatmeal comprising oat flakes and a powder. In some embodiments, the powder comprises flavors, sweeteners, and at least one texturizer. In some embodiments, the at least one texturizer comprises 0.09 to 0.3 wt. % whole grain oat flour; and/or the whole grain oat flour is highly dispersible in water so that there are no lumps of the whole grain oat flour in a mixture of the whole grain oat flour and water at 25° C. after stirring the mixture for 5 seconds.

In a second aspect, U.S. patent application Ser. No. 15/481,286 includes or can be modified to include a ready-to-eat soup comprising 2 to 10 wt. % of whole grain oat flour based on total weight of the soup. In some embodiments, the whole grain oat flour provides at least ½ serving of whole grains per 8 oz serving; and/or the whole grain oat flour is highly dispersible in water so that there are no lumps of the whole grain oat flour in a mixture of the whole grain oat flour and water at 25° C. after stirring the mixture for 5 seconds.

In a third aspect, U.S. patent application Ser. No. 15/481,286 includes or can be modified to include a frozen commodity selected from the group consisting of ice cream and slushies. In some embodiments, the frozen commodity comprises whole grain oat flour in an amount of 2 to 10 wt. % based on total weight of the frozen commodity; and/or the whole grain oat flour is highly dispersible in water so that there are no lumps of the whole grain oat flour in a mixture of the whole grain oat flour and water at 25° C. after stirring the mixture for 5 seconds.

### Additional Embodiments

The following clauses are offered as further description of the disclosed invention:

1. An oat composition comprising:
water;
1 wt. % to 10 wt. % (e.g., 2.2 to 4.3 wt. % or 3.3 to 6.7 wt. %) hydrolyzed oats (e.g., hydrolyzed whole grain oats) comprising hydrolyzed starch;
undissolved solids;
dissolved solids;
emulsifier;
suspension stabilizer (e.g., activated suspension stabilizer), and optionally wherein the suspension stabilizer has been activated (e.g., by heat treatment, during homogenization, during pasteurization or a combination thereof), optionally wherein the oat composition comprises a concentration of suspension stabilizer effective to maintain the undissolved solids in suspension in the oat composition, for example, when the suspension stabilizer has been activated, optionally wherein the undissolved solids are deemed to be maintained in suspension if at least 90% (e.g., at least 90, 91, 92, 93, 94, 95, 96, 97, 98 or 99% and up to 100%) by volume of the oat composition is a single solid-in-liquid suspension at the end of a suspension test, wherein the solid-in-liquid suspension comprises water and a majority (e.g., more than 50 wt. %, at least 90 wt. %, or more than 90 wt. %) of the undissolved solids in the oat composition;

optionally, wherein the suspension test comprises (i) providing 100 mL of the oat composition at 20° C. in a graduated cylinder and in air at 20° C., wherein the graduated cylinder has an inner diameter of 3 cm, has an inner height of 25 cm and is configured to measure at least 100 mL of water contained by the graduated cylinder, (ii) closing the graduated cylinder so that the oat composition will not escape from the graduated cylinder during a mixing step, (iii) performing the mixing step by vertically orienting a central axis of the graduated cylinder and vertically oscillating the graduated cylinder at an amplitude of 2.5 cm so that the graduated cylinder is displaced 2.5 cm above and 2.5 cm below a starting position at a rate of 1 oscillation per second for 15 seconds, and (iv) allowing the graduated cylinder to remain stationary for 2 hours after the mixing step;

optionally, wherein the viscosity of the oat composition is 6 to 30 cP at 8° C. and at a shear rate of 50/s, for example, when the suspension stabilizer has been activated; and

optionally wherein the hydrolyzed oats are provided by hydrolyzing starch in starting oats (e.g., starting whole grain oats); optionally wherein the starting oats comprise a pre-hydrolysis starch-to-protein mass ratio, optionally wherein the hydrolyzed oats comprise a post-hydrolysis starch-to-protein mass ratio, optionally wherein the post-hydrolysis starch-to-protein mass ratio is equal to the pre-hydrolysis starch-to-protein mass ratio within a tolerance of +/−30, 25, 20, 15, 10, 5, 4, 3, 2 or 1% of the pre-hydrolysis starch-to-protein mass ratio.

2. The oat composition of any preceding clause, wherein the oat composition is a milk alternative.

3. The oat composition of any preceding clause, wherein the oat composition comprises 0 to 8, 0 to 7, 0 to 6, 1 to 5, 1 to 4, 1.5 to 3.5, or 2.0 to 3.0 wt. % fat.

4. The oat composition of any preceding clause, wherein the oat composition comprises: an oil-in-water emulsion comprising droplets of fat dispersed in water.

5. The oat composition of any preceding clause, wherein at least 90, 91, 92, 93, 94, 95, 96, 97, 98 or 99 wt. % and up to 100 wt. % of fat in the oat composition is in an oil-in-water emulsion.

6. The oat composition of any preceding clause, wherein at least 90, 91, 92, 93, 94, 95, 96, 97, 98 or 99 wt. % and up to 100 wt. % of fat in the oat composition has a particle size of greater than 0 micrometers and up to 10 micrometers.

7. The oat composition of any preceding clause, wherein the oat composition is a beverage.

8. The oat composition of any preceding clause, wherein the starting whole grain oats are in the form of a starting whole grain (e.g., whole grain oat flour).

9. The oat composition of any preceding clause, wherein the hydrolyzed oats are in the form of a hydrolyzed whole grain (e.g., a hydrolyzed whole grain oat flour), optionally, wherein the hydrolyzed whole grain oat flour has a Dw90 particle size equal to no more than about 300 micrometers or 297 micrometers (about U.S. #50 Sieve Size).

10. The oat composition of any preceding clause, wherein the oat composition is a beverage and the suspension stabilizer makes up 0.01 to 0.12 wt. % (e.g., 0.01 to 0.04 wt. %) of the oat composition.

11. The oat composition of any preceding clause, wherein the oat composition comprises a viscosity of 15-20 cP at 8° C. and a shear rate of 50/s.

12. The oat composition of any preceding clause, wherein the suspension stabilizer makes up 0.01 to 0.15 wt. % (0.01 to 0.12 wt. % or 0.060 to 0.15 wt. %) of the oat composition.

13. The oat composition of any preceding clause, wherein the oat composition comprises a viscosity of 20-30 cP at 8° C. at a shear rate of 50/s.

14. The oat composition of any preceding clause, wherein the suspension stabilizer makes up 0.25 to 0.55 wt. % of the oat composition.

15. The oat composition of any preceding clause, wherein the suspension stabilizer comprises a hydrocolloid.

16. The oat composition of any preceding clause, wherein the viscosity of the oat composition is at least 6, 7, 8, 9, 10, 15 or 20 cP at 8° C. at a shear rate of 50/s, no more than 30, 25, 20, 15, 10 cP at 8° C. at a shear rate of 50/s, or a combination thereof.

17. The oat composition of any preceding clause, wherein the hydrolyzed oats (e.g., hydrolyzed whole grain oats) have or a hydrolyzed product composition comprising the hydrolyzed oats and included in the oat composition has a peak rapid visco analyzer (RVA) viscosity equal to 1500 to 2000 cP, wherein the peak RVA viscosity is measured using the following RVA protocol: first, mixing the hydrolyzed oats or hydrolyzed product composition with water by turning a shaft with a paddle at 960 rpm +/−50 rpm for 10 seconds to form a peak-RVA-test mixture comprising 14.3 wt. % total solids and a remainder of water and, second, continuously stirring the peak-RVA-test mixture by turning the shaft with the paddle at 160 rpm +/−20 rpm and continuously measuring the viscosity of the peak-RVA-test mixture at least once per second during the following temperature-modification protocol: (i) maintaining the peak-RVA-test mixture at a temperature of 25° C. +/−2° C. for 90 seconds; (ii) increasing the temperature of the peak-RVA-test mixture to 95° C. +/−2° C. over 5 minutes (e.g., at a constant rate of 19° C. per minute within a tolerance of +/−2° C. per minute); (iii) maintaining the peak-RVA-test mixture at 95° C. +/−2° C. for 3 minutes; (iv) decreasing the temperature of the peak-RVA-test mixture to 25° C. +/−2° C. over 5 minutes (e.g., at a constant rate of 5° C. per minute within a tolerance of +/−2° C. per minute); and (v) maintaining the peak-RVA-test mixture at 25° C. +/−2° C. for 5 minutes; wherein a maximum viscosity of the peak-RVA-test mixture during the temperature-modification protocol is the peak RVA viscosity of the hydrolyzed oats or the hydrolyzed product composition.

18. The oat composition of any preceding clause, wherein the hydrolyzed oats comprise oat starch molecules, wherein the oat starch molecules have an average molecular weight equal to no more than 7*10\hat{ }6, 5.8*10\hat{ }6, 3.0*10\hat{ }6, 2.5*10\hat{ }6, 2.0*10\hat{ }6, 1.7*10\hat{ }6, 1.5*10\hat{ }6, 1.0*10\hat{ }6, 5*10\hat{ }5, 4*10\hat{ }5, 3*10\hat{ }5 or 2\hat{ }10*5 g/mol; at least 1.7*10\hat{ }5, 1.8*10\hat{ }5, 1.9*10\hat{ }5, 2*10\hat{ }5, 3*10\hat{ }5, 4*10\hat{ }5, 5*10\hat{ }5, 1.0*10\hat{ }6, 1.5*10\hat{ }6, 1.7*10\hat{ }6, 2.0*10\hat{ }6 or 2.5*10\hat{ }6, 3.0*10\hat{ }6, 5.8*10\hat{ }6, 7*10\hat{ }6 g/mol; or a combination thereof.

19. The oat composition of any preceding clause, wherein the hydrolyzed oats comprise oat starch molecules, wherein the average molecular weight of the hydrolyzed starch molecules in the composition is equal to 1.7*10\hat{ }5 to 3*10\hat{ }6 g/mol.

20. The oat composition of any preceding clause, wherein the average molecular weight of the hydrolyzed starch is a fraction of the molecular weight of unhydrolyzed starch equivalent (e.g., in kind and condition) to the hydrolyzed starch, except that the unhydrolyzed starch molecules have not been hydrolyzed; wherein the fraction is about 0.27 to 0.75.

21. The oat composition of any preceding clause, wherein the suspension stabilizer is gellan gum (e.g., high methoxy gellan gum, high acyl gellan gum, or HM-B gellan gum), a composition comprising both microcrystalline cellulose (MCC) and carboxymethyl cellulose (CMC), or a combination thereof.

22. The oat composition of any preceding clause, wherein the hydrolyzed oats are provided by hydrolyzing starch in starting oats (e.g., starting whole grain oats); wherein the hydrolyzed oats comprise a post-hydrolysis starch-to-protein mass ratio, wherein the post-hydrolysis starch-to-protein mass ratio is equal to about 3.1:1 to 5.1:1.

23. The oat composition of any preceding clause, wherein the hydrolyzed oats are provided by hydrolyzing starch in starting oats (e.g., starting whole grain oats); wherein the starting oats comprise a pre-hydrolysis fat-to-protein mass ratio; wherein the hydrolyzed oats comprise a post-hydrolysis fat-to-protein mass ratio; wherein the post-hydrolysis fat-to-protein mass ratio is equal to the pre-hydrolysis fat-to-protein mass ratio within a tolerance of +/−30, 25, 20, 15, 10, 5, 4, 3, 2 or 1% of the pre-hydrolysis fat-to-protein mass ratio.

24. The oat composition of any preceding clause, wherein the hydrolyzed oats are provided by hydrolyzing starch in starting oats (e.g., starting whole grain oats); wherein the hydrolyzed oats comprise a post-hydrolysis fat-to-protein mass ratio, wherein the post-hydrolysis fat-to-protein mass ratio is equal to about 0.5:1 to 0.71:1.

25. The oat composition of any preceding clause, wherein the hydrolyzed oats are provided by hydrolyzing starch in starting oats (e.g., starting whole grain oats); wherein the starting oats (e.g., starting whole grain oats) comprise a pre-hydrolysis sugar-to-protein mass ratio, wherein the hydrolyzed oats comprise a post-hydrolysis sugar-to-protein mass ratio, wherein the post-hydrolysis sugar-to-protein mass ratio is equal to the pre-hydrolysis sugar-to-protein mass ratio within a tolerance of +/−30, 25, 20, 15, 10, 5, 4, 3, 2, or 1% of the pre-hydrolysis sugar-to-protein mass ratio.

26. The oat composition of any preceding clause, wherein the hydrolyzed oats are provided by hydrolyzing starch in starting oats (e.g., starting whole grain oats); wherein the hydrolyzed oats comprise a post-hydrolysis sugar-to-protein mass ratio, wherein the post-hydrolysis sugar-to-protein mass ratio is equal to about 0.07:1 to 0.091:1.

27. The oat composition of any preceding clause, wherein the hydrolyzed oats are provided by hydrolyzing starch in starting oats (e.g., starting whole grain oats); wherein the starting oats comprise a pre-hydrolysis beta-glucan-to-protein mass ratio, wherein the hydrolyzed oats comprise a post-hydrolysis beta-glucan-to-protein mass ratio, wherein the post-hydrolysis beta-glucan-to-protein mass ratio is equal to the pre-hydrolysis beta-glucan-to-protein mass ratio within a tolerance of +/−30, 25, 20, 15, 10, 5, 4, 3, 2 or 1% of the pre-hydrolysis beta-glucan-to-protein mass ratio.

28. The oat composition of any preceding clause, wherein the hydrolyzed oats are provided by hydrolyzing starch in starting oats (e.g., starting whole grain oats); wherein the hydrolyzed oats comprise a post-hydrolysis beta-glucan-to-protein mass ratio, wherein the post-hydrolysis beta-glucan-to-protein mass ratio is equal to about 0.26:1 to 0.4:1.

29. The oat composition of any preceding clause, wherein the hydrolyzed oats are provided by hydrolyzing starch in starting oats (e.g., starting whole grain oats); wherein the starting oats comprise a pre-hydrolysis beta-glucan-to-protein mass ratio, wherein the hydrolyzed oats comprise a post-hydrolysis beta-glucan-to-protein mass ratio, wherein the post-hydrolysis beta-glucan-to-protein mass ratio is equal to the pre-hydrolysis beta-glucan-to-protein mass ratio within a tolerance of +/−30, 25, 20, 15, 10, 5, 4, 3, 2 or 1% of the pre-hydrolysis beta-glucan-to-protein mass ratio.

30. The oat composition of any preceding clause, comprising: greater than 0, at least 3 or at least 4 wt. % total solids, and no more than 12, 10 or 9 wt. % total solids;

greater than 0, at least 3 or at least 4 wt. % undissolved solids, and no more than 12, 10 or 9 wt. % undissolved solids;

about 82.92 to 92.13 wt. % water moisture;

about 2.3 to 4.5 wt. % hydrolyzed product composition, wherein the hydrolyzed product composition comprises hydrolyzed oats (e.g., hydrolyzed whole grain oats); or

a combination thereof.

31. The oat composition of any preceding clause, comprising:

about 0.5 to 1.0 wt. % vegetable oil;

about 0.1 to 1.0 wt. % salt;

about 0.15 to 0.25 wt. % emulsifier (e.g., gum acacia);

about 0.02 to 0.03 wt. % suspension stabilizer (e.g., gellan gum, high methoxy gellan gum, high acyl gellan gum, HM-B gellan gum, a composition comprising both microcrystalline cellulose (MCC) and carboxymethyl cellulose (CMC) or a combination thereof);

about 0.8 to 1.3 wt. % inulin;

fiber sufficient to provide a good source of dietary fiber according to the most recent U.S. Food and Drug Administration (FDA) requirements for food labeling that are now in effect, which are incorporated herein by reference (e.g., provide at least 10%, or 10 to 19%, of the Reference Daily Intake (RDI) value, or Daily Reference Value (DRV) for dietary fiber, wherein the RDI value is 28 grams dietary fiber);

a water soluble vitamin (e.g., vitamin B, C or a combination thereof) sufficient to provide a good source of the water soluble vitamin according to the most recent U.S. Food and Drug Administration (FDA) requirements for food labeling that are now in effect, which are incorporated herein by reference (e.g., provide at least 10%, or 10 to 19%, of the Reference Daily Intake (RDI) value, or Daily Reference Value (DRV) for the water soluble vitamin);

a fat soluble vitamin (e.g., vitamin A, D, E, K or a combination thereof) sufficient to provide a good source of the fat soluble vitamin according to the most recent U.S. Food and Drug Administration (FDA) requirements for food labeling that are now in effect, which are incorporated herein by reference (e.g., provide at least 10%, or 10 to 19%, of the Reference Daily Intake (RDI) value, or Daily Reference Value (DRV) for the fat soluble vitamin);

0.00 to about 0.01 wt. % vitamin; or

a combination thereof.

32. The oat composition of any preceding clause, comprising: about 0 to 10 wt. % added sweetener.

33. The oat composition of any preceding clause, comprising:

about 0 to 5 wt. % added sweetener.

34. The oat composition of any preceding clause, wherein the added sweetener comprises sugar (e.g., sucrose).

35. The oat composition of any preceding clause, wherein the composition comprises vegetable oil, optionally wherein the vegetable oil comprises sunflower oil.

36. The oat composition of any preceding clause, wherein the composition comprises salt, optionally wherein the salt comprises any calcium salt and sodium chloride.

37. The oat composition of any preceding clause, wherein the hydrolyzed product composition comprises:

about 98.18 to 99.48 wt. % oat flour;

about 0.24 to 0.74 wt. % tocopherols;

about 0.24 to 0.74 wt. % calcium silicate;

about 0.04 to 0.54 wt. % (e.g., about 0.04 to 0.34 wt. %) alpha-amylase enzyme; or a combination thereof.

38. The oat composition of any preceding clause, wherein the hydrolyzed product composition comprises about 0.24 to about 0.54 wt. % alpha-amylase enzyme.

39. The oat composition of any preceding clause, wherein the hydrolyzed whole grain oats comprise:

about 3.49 to 4.03 wt. % beta-glucan;
about 7.18 to 7.63 wt. % fat;
about 8.12 to 8.98 wt. % water moisture;
about 12.75 to 12.81 wt. % protein;
about 52.63 to 53.01 wt. % starch;
about 0.96 to 1.10 wt. % sugar (e.g., sucrose);
about 9.33 to 9.88 wt. % dietary fiber; or
a combination thereof.

40. A method for making an oat composition, comprising:

hydrolyzing starch in starting oats (e.g., starting whole grain oats) to provide hydrolyzed oats (e.g., hydrolyzed whole grain oats) comprising hydrolyzed starch;

combining the hydrolyzed oats, the water, the emulsifier and the suspension stabilizer (e.g., combining the water, the emulsifier and the suspension stabilizer with a hydrolyzed product composition comprising the hydrolyzed oats) to provide the oat composition of any one of clauses 1-39.

41. The method of any preceding clause:

wherein the hydrolyzing comprises:

providing a starting composition comprising: starting oats (e.g., starting whole grain oats), an optional antioxidant (e.g. mixed tocopherols), water, and an enzyme (e.g., alpha-amylase); and

using the alpha-amylase to enzymatically hydrolyze starch in the starting oats (e.g., starting whole grain oats) (e.g., in a hydrolysis reactor, extruder, conduit, etc.) to provide the hydrolyzed oats (e.g., as part of a hydrolyzed product composition that comprises the hydrolyzed oats).

42. The method of any preceding clause, wherein the method comprises decreasing an average size of the hydrolyzed oats (e.g., by grinding, milling, etc.) to provide size-reduced hydrolyzed oats.

43. The method of any preceding clause, wherein the combining step comprises:

mixing the water and the hydrolyzed product composition (e.g., hydrolyzed oats, or hydrolyzed whole grain oats) to provide an oat slurry at a temperature of about 54° C. to 66° C., optionally wherein the oat slurry comprises no more than about 12, 10 or 9 wt. % undissolved solids and greater than 0, at least 3 or at least 4 wt. % undissolved solids, optionally wherein the oat slurry comprises no more than about 12, 10 or 9 wt. % total solids and greater than 0, at least 3 or at least 4 wt. % total solids;

adding inulin, gum acacia, sunflower oil, and water and optionally salt to the oat slurry to provide an emulsion-stabilized oat slurry, optionally wherein the emulsion-stabilized oat slurry comprises no more than about 12, 10 or 9 wt. % undissolved solids and greater than 0, at least 3 or at least 4 wt. % undissolved solids, optionally wherein the emulsion-stabilized oat slurry comprises no more than about 12, 10 or 9 wt. % total solids and greater than 0, at least 3 or at least 4 wt. % total solids;

cooling the emulsion-stabilized oat slurry to less than about 45° C., 43.3° C., 37.8 C or 35° C. and optionally more than about 6° C., 10° C., 15° C. or 20° C. to provide a cooled oat slurry; and

adding the suspension stabilizer to the cooled oat slurry to provide a suspension-stabilized oat slurry;

optionally wherein the method comprises activating the suspension stabilizer in the suspension-stabilized oat slurry to provide an activated suspension-stabilized oat slurry (e.g., by heat-treating the suspension-stabilized oat slurry; during homogenization of the suspension-stabilized oat slurry, which can also be a chilled oat slurry; during pasteurization of the suspension-stabilized oat slurry, chilled oat slurry or homogenized oat composition; or a combination thereof).

44. The method of clause 43, comprising introducing (e.g. mixing) texturizer, vitamins, flavors, or a combination thereof to the emulsion-stabilized oat slurry after the cooling step to provide a resulting oat slurry (e.g., suspension-stabilized oat slurry or flavored oat slurry).

45. The method of clause 44, comprising chilling the resulting oat slurry (e.g., suspension-stabilized oat slurry or flavored oat slurry) to a temperature of about 2 to 6° C. after the introducing step, thereby providing a chilled oat slurry, optionally wherein the chilling the resulting oat slurry occurs before activating the suspension-stabilizer.

46. The method of clause 43, 44 or 45 wherein the combining step comprises introducing gum acacia, optionally a mass of a water soluble vitamin equal to 10 to 19% of the Reference Daily Intake (RDI) of the water soluble vitamin, optionally a mass of a fat soluble vitamin equal to 10 to 19% of the Reference Daily Intake (RDI) of the fat soluble vitamin, and optionally a vanilla flavor to the cooled oat slurry to provide a resulting oat slurry (e.g., suspension-stabilized oat slurry or flavored oat slurry).

47. The method of any preceding clause, comprising mixing the water, the hydrolyzed whole grain oat, and salt to provide an oat slurry at a temperature of about 54° C. to 66° C.

48. The method of any preceding clause, wherein the adding step comprises adding a sweetener.

49. The method of any preceding clause, wherein, after activation of the suspension stabilizer, a viscosity in cP of the suspension-stabilized oat slurry is at least 1.5, 2.0, 2.5, 3.0, 3.5 or 4.0 times greater than and optionally no more than 5.0, 4.5, 4.0, 3.5, 3.0, 2.5, or 2.0 times greater than a viscosity in cP of the suspension-stabilized oat slurry before activation, wherein the suspension-stabilized oat slurry viscosity after activation and the suspension-stabilized oat slurry viscosity before activation are measured at 8° C. and at a shear rate of 50/s.

50. The method of any preceding clause, comprising homogenizing the resulting oat slurry (e.g., suspension-stabilized oat slurry, flavored oat slurry, or chilled oat slurry) at about 1000 to 3000 psig (6,894 to 20,685 kPa absolute) and about room temperature to provide the homogenized oat composition; heating the homogenized oat composition to pasteurize the homogenized oat composition to provide a pasteurized oat composition; and post-pasteurization-homogenizing the pasteurized oat composition at about 1000 to 3000 psig (6,894 to 20,685 kPa absolute) and at 60 to 90° C. (e.g., 70 to 90° C., or 75 to 85° C., or 82° C.) to provide the oat composition.

51. The method of any preceding clause, comprising homogenizing the resulting oat slurry (e.g., suspension-stabilized oat slurry, flavored oat slurry, or chilled oat slurry) at about 1000 to 3000 psig (6,894 to 20,685 kPa absolute) and about room temperature to provide the homogenized oat composition; heating the homogenized oat composition to pasteurize the homogenized oat composition to provide a pasteurized oat composition; and post-pasteurization-homogenizing the pasteurized oat composition at about 1500 to 2000 psig (10,342 to 13,790 kPa absolute) and at 60 to 90° C. (e.g., 70 to 90° C., or 75 to 85° C., or 82° C.) to provide the oat composition.

52. The method of any preceding clause, comprising homogenizing the resulting oat slurry (e.g., suspension-stabilized oat slurry or flavored oat slurry) at about 1500 to 2000 psig (10,342 to 13,790 kPa absolute) and about room temperature to provide the homogenized oat composition; heating the homogenized oat composition to pasteurize the homogenized oat composition to provide a pasteurized oat composition; and post-pasteurization-homogenizing the pasteurized oat composition at about 1000 to 3000 psig (6,894 to 20,685 kPa absolute) and at 60 to 90° C. (e.g., 70 to 90° C., or 75 to 85° C., or 82° C.) to provide the oat composition.

53. The method of any preceding clause, comprising homogenizing the resulting oat slurry (e.g., suspension-stabilized oat slurry or flavored oat slurry) at about 1500 to 2000 psig (10,342 to 13,790 kPa absolute) and about room temperature to provide the homogenized oat composition; heating the homogenized oat composition to pasteurize the homogenized oat composition to provide a pasteurized oat composition; and post-pasteurization-homogenizing the pasteurized oat composition at about 1500 to 2000 psig (10,342 to 13,790 kPa absolute) and at 60 to 90° C. (e.g., 70 to 90° C., or 75 to 85° C., or 82° C.) to provide the oat composition.

54. The method of any preceding clause, comprising storing the oat composition in an aseptic container and at a temperature greater than 0° C. to no more than 6° C.

55. The method of any preceding method clause, wherein the method uses a material described in any preceding oat composition clause, wherein the method is used to make the composition of any preceding oat composition clause, or a combination thereof.

Although the present disclosure has provided many examples of systems, apparatuses, and methods, it should be understood that the components of the systems, apparatuses and method described herein are compatible and additional embodiments can be created by combining one or more elements from the various embodiments described herein. As an example, in some embodiments, a method described herein can further comprise one or more elements of a system described herein or a selected combination of elements from any combination of the systems or apparatuses described herein.

Furthermore, in some embodiments, a method described herein can further comprise using a system described herein, using one or more elements of a system described herein, or using a selected combination of elements from any combination of the systems described herein.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Where language, for example, “for” or “to”, is used herein in conjunction with an effect, function, use or purpose, an additional embodiment can be provided by substituting “for” or “to” with “configured for/to” or “adapted for/to.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

As used herein, examples of “substantially” include: “more so than not,” “mostly,” and “at least 30, 40, 50, 60, 70, 80, 90, 95, 96, 97, 98 or 99%” with respect to a referenced characteristic. With respect to vectors, directions, movements or angles, that are “substantially” in the same direction as or parallel to a reference vector, direction, movement, angle or plane, “substantially” can also mean “at least a component of the vector, direction, movement or angle specified is parallel to the reference vector, direction, movement, angle or plane,” although substantially can also mean within plus or minus 45, 40, 35, 30, 25, 20, 15, 10, 5, 4, 3, 2, or 1 degrees of the reference vector, direction, movement, angle or plane.

As used herein, examples of “about” and “approximately” include a specified value or characteristic to within plus or minus 30, 25, 20, 15, 10, 5, 4, 3, 2, or 1% of the specified value or characteristic.

Unless otherwise specified, percentages of a component in a composition are given in terms of weight percentages.

While this invention has been particularly shown and described with reference to preferred embodiments, it will be understood by those skilled in the art that various changes in form and detail can be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An oat composition comprising:
water;
1 wt. % to 10 wt. % hydrolyzed whole grain oats comprising hydrolyzed starch;
undissolved solids;
dissolved solids;
emulsifier; and
suspension stabilizer, wherein the suspension stabilizer is activated and wherein a concentration of the suspension stabilizer in the oat composition is effective to maintain the undissolved solids in suspension in the oat composition, wherein the undissolved solids are deemed to be maintained in suspension if at least 90% by volume of the oat composition is a single solid-in-liquid suspension at the end of a suspension test, wherein the solid-in-liquid suspension comprises water and a majority of the undissolved solids in the oat composition;
wherein the suspension test comprises (i) providing 100 mL of the oat composition at 20° C. in a graduated cylinder and in air at 20° C., wherein the graduated cylinder has an inner diameter of 3 cm, has an inner height of 25 cm and is configured to measure at least 100 mL of water contained by the graduated cylinder, (ii) closing the graduated cylinder so that the oat composition will not escape from the graduated cylinder during a mixing step, (iii) performing the mixing step by vertically orienting a central axis of the graduated cylinder and vertically oscillating the graduated cylinder at an amplitude of 2.5 cm so that the graduated cylinder is displaced 2.5 cm above and 2.5 cm below a starting position at a rate of 1 oscillation per second for 15 seconds, and (iv) allowing the graduated cylinder to remain stationary for 2 hours after the mixing step;
wherein the viscosity of the oat composition is 6 to 30 cP at 8° C. and at a shear rate of 50/s; and
wherein the hydrolyzed whole grain oats are provided by hydrolyzing starch in starting whole grain oats; wherein the starting whole grain oats comprise a pre-hydrolysis starch-to-protein mass ratio, wherein the hydrolyzed whole grain oats comprise a post-hydrolysis starch-to-protein mass ratio, wherein the post-hydrolysis starch-to-protein mass ratio is equal to the pre-hydrolysis starch-to-protein mass ratio within a tolerance of +/−10% of the pre-hydrolysis starch-to-protein mass ratio.

2. The oat composition of claim 1, wherein the oat composition is a milk alternative.

3. The oat composition of claim 1, wherein the oat composition comprises 0 to 8 wt. % fat.

4. The oat composition of claim 1, wherein the oat composition comprises: an oil-in-water emulsion comprising droplets of fat dispersed in water.

5. The oat composition of claim 4, wherein at least 90 wt. % and up to 100 wt. % of fat in the oat composition is in the oil-in-water emulsion.

6. The oat composition of claim 4, wherein at least 90 wt. % and up to 100 wt. % of fat in the oat composition has a particle size of greater than 0 micrometers and up to 10 micrometers.

7. The oat composition of claim 1, wherein the oat composition is a beverage.

8. The oat composition of claim 1, wherein the hydrolyzed whole grain oats are in the form of a hydrolyzed whole grain oat flour having a Dw90 particle size equal to no more than U.S. #50 Sieve Size.

9. The oat composition of claim 1, wherein the oat composition is a beverage and the suspension stabilizer makes up 0.01 to 0.12 wt. % of the oat composition.

10. The oat composition of claim 1, wherein the suspension stabilizer comprises a hydrocolloid.

11. The oat composition of claim 1, wherein the hydrolyzed whole grain oats have a peak rapid visco analyzer (RVA) viscosity equal to 1500 to 2000 cP, wherein the peak RVA viscosity is measured using the following RVA protocol: first, mixing the hydrolyzed whole grain oats with water by turning a shaft with a paddle at 960 rpm +/−50 rpm for 10 seconds to form a peak-RVA-test mixture comprising 14.3 wt. % total solids and a remainder of water and, second, continuously stirring the peak-RVA-test mixture by turning the shaft with the paddle at 160 rpm +/−20 rpm and continuously measuring the viscosity of the peak-RVA-test mixture at least once per second during the following temperature-modification protocol: (i) maintaining the peak-RVA-test mixture at a temperature of 25° C. +/−2° C. for 90 seconds; (ii) increasing the temperature of the peak-RVA-test mixture to 95° C. +/−2° C. over 5 minutes; (iii) maintaining the peak-RVA-test mixture at 95° C. +/−2° C. for 3 minutes; (iv) decreasing the temperature of the peak-RVA-test mixture to 25° C. +/−2° C. over 5 minutes; and (v) maintaining the peak-RVA-test mixture at 25° C. +/−2° C. for 5 minutes; wherein a maximum viscosity of the peak-RVA-test mixture during the temperature-modification protocol is the peak RVA viscosity of the hydrolyzed whole grain oats.

12. The oat composition of claim 1, wherein the hydrolyzed whole grain oats comprise oat starch molecules, wherein the oat starch molecules have an average molecular weight equal to 1.7*10\hat{ }5 to 3.0*10\hat{ }6 g/mol.

13. The oat composition of claim 1, wherein the hydrolyzed whole grain oats are provided by hydrolyzing starch in the starting whole grain oats; wherein the post-hydrolysis starch-to-protein mass ratio is equal to 3.1:1 to 5.1:1.

14. The oat composition of claim 1, wherein the oat composition comprises:
4 to 9 wt. % total solids;
82.92 to 92.13 wt. % water moisture; and
2.3 to 4.5 wt. % hydrolyzed product composition, wherein the hydrolyzed product composition comprises the hydrolyzed whole grain oats.

15. The oat composition of claim 1, wherein the oat composition comprises:
0.5 to 1.0 wt. % vegetable oil;
0.1 to 1.0 wt. % salt;
0.15 to 0.25 wt. % gum acacia;
0.02 to 0.03 wt. % gellan gum; and
0.8 to 1.3 wt. % inulin.

16. The oat composition of claim 1, wherein the oat composition comprises 0 to 10 wt. % added sucrose.

17. The oat composition of claim 1, wherein the oat composition comprises salt, and wherein the salt comprises tri-calcium phosphate and sodium chloride.

18. The oat composition of claim 14, wherein the hydrolyzed product composition comprises:
98.18 to 99.48 wt. % oat flour;
0.24 to 0.74 wt. % tocopherols;
0.24 to 0.74 wt. % calcium silicate; and
0.04 to 0.54 wt. % alpha-amylase enzyme.

19. The oat composition of claim 1, wherein the hydrolyzed whole grain oats comprise:
3.49 to 4.03 wt. % beta-glucan;
7.18 to 7.63 wt. % fat;
8.12 to 8.98 wt. % water moisture;
12.75 to 12.81 wt. % protein;
52.63 to 53.01 wt. % starch;
0.96 to 1.10 wt. % sugar; and
9.33 to 9.88 wt. % dietary fiber.

20. A method for making an oat composition, comprising:
hydrolyzing starch in starting whole grain oats to provide hydrolyzed whole grain oats, wherein the hydrolyzed whole grain oats comprise hydrolyzed starch;
combining the hydrolyzed whole grain oats, water, emulsifier, and suspension stabilizer to provide the oat composition, wherein the oat composition comprises:
the water;
1 wt. % to 10 wt. % of the hydrolyzed whole grain oats comprising the hydrolyzed starch;
undissolved solids;
dissolved solids;
the emulsifier; and
the suspension stabilizer, wherein the suspension stabilizer is activated and wherein a concentration of the suspension stabilizer in the oat composition is effective to maintain the undissolved solids in suspension in the oat composition, wherein the undissolved solids are deemed to be maintained in suspension if at least 90% by volume of the oat composition is a single solid-in-liquid suspension at the end of a suspension test, wherein the solid-in-liquid suspension comprises water and a majority of the undissolved solids in the oat composition;
wherein the suspension test comprises (i) providing 100 mL of the oat composition at 20° C. in a graduated cylinder and in air at 20° C., wherein the graduated cylinder has an inner diameter of 3 cm, has an inner height of 25 cm and is configured to measure at least 100 mL of water contained by the graduated cylinder, (ii) closing the graduated cylinder so that the oat composition will not escape from the graduated cylinder during a mixing step, (iii) performing the mixing step by vertically orienting a central axis of the graduated cylinder and vertically oscillating the graduated cylinder at an amplitude of 2.5 cm so that the graduated cylinder is displaced 2.5 cm above and 2.5 cm below a starting position at a rate of 1 oscillation per second for 15 seconds, and (iv) allowing the graduated cylinder to remain stationary for 2 hours after the mixing step;
wherein the viscosity of the oat composition is 6 to 30 cP at 8° C. and at a shear rate of 50/s; and
wherein the hydrolyzed whole grain oats are provided by hydrolyzing starch in the starting whole grain oats; wherein the starting whole grain oats comprise a pre-hydrolysis starch-to-protein mass ratio, wherein the hydrolyzed whole grain oats comprise a post-hydrolysis starch-to-protein mass ratio, wherein the post-hydrolysis starch-to-protein mass ratio is equal to the pre-hydrolysis starch-to-protein mass ratio within a tolerance of +/−10% of the pre-hydrolysis starch-to-protein mass ratio.

21. The method of claim 20:
wherein the hydrolyzing comprises:
providing a starting composition comprising: the starting whole grain oats, an antioxidant, water, and alpha-amylase; and
using the alpha-amylase to enzymatically hydrolyze starch in the starting whole grain oats to provide the hydrolyzed whole grain oats.

22. The method of claim 20, wherein the method comprises decreasing an average size of the hydrolyzed whole grain oats to provide size-reduced hydrolyzed whole grain oats.

23. The method of claim 20, wherein the combining step comprises:
mixing the water and the hydrolyzed whole grain oats to provide an oat slurry at a temperature of 54° C. to 66° C.;
adding inulin, gum acacia, sunflower oil, and water to the oat slurry to provide an emulsion-stabilized oat slurry comprising no more than 10 wt. % total solids and greater than 0 wt. % total solids;
cooling the emulsion-stabilized oat slurry to less than 35° C. and greater than 6° C. to provide a cooled oat slurry;
introducing the suspension stabilizer to the cooled oat slurry to provide a suspension-stabilized oat slurry; and
activating the suspension stabilizer in the suspension-stabilized oat slurry by heat-treating the suspension-stabilized oat slurry, thereby providing an activated suspension-stabilized oat slurry.

24. The method of claim 23, wherein the suspension stabilizer comprises high acyl gellan gum.

25. The method of claim 24, wherein the combining step comprises chilling the suspension-stabilized oat slurry to a temperature of 2 to 6° C. before activating the suspension stabilizer, thereby providing a chilled oat slurry.

26. The method of claim 23, wherein the combining step comprises mixing the water, the hydrolyzed whole grain oats, and salt to provide the oat slurry at a temperature of 54° C. to 66° C.

27. The method of claim 23, wherein the adding step comprises adding a sweetener.

28. The method of claim 23, wherein a viscosity in cP of the activated suspension-stabilized oat slurry is 1.5 to 4 times a viscosity in cP of the suspension-stabilized oat slurry before activation, wherein the viscosity of the activated suspension-stabilized oat slurry and the viscosity of the suspension-stabilized oat slurry before activation are measured at 8° C. and at a shear rate of 50/s.

29. The method of claim 24, comprising homogenizing the suspension-stabilized oat slurry at 6,894 to 20,685 kPa and 15 to 105° C. to provide a homogenized oat composition; heating the homogenized oat composition to pasteurize the homogenized oat composition, thereby providing a pasteurized oat composition; and post-pasteurization-homogenizing the pasteurized oat composition at 6,894 to 20,685 kPa and at 60 to 90° C. to provide the oat composition.

30. The method of claim 24, comprising homogenizing the suspension-stabilized oat slurry at 10,342 to 13,790 kPa and 15 to 105° C. to provide a homogenized oat composition; heating the homogenized oat composition to pasteurize the homogenized oat composition, thereby providing a pasteurized oat composition; and post-pasteurization-homogenizing the pasteurized oat composition at 6,894 to 20,685 kPa and at 60 to 90° C. to provide the oat composition.

31. The method of claim 20, comprising storing the oat composition in an aseptic container and at a temperature greater than 0° C. to no more than 6° C.

32. The method of claim 20, wherein the hydrolyzed whole grain oats are provided by hydrolyzing starch in the starting whole grain oats; wherein the starting whole grain oats comprise a pre-hydrolysis fat-to-protein mass ratio; wherein the hydrolyzed whole grain oats comprise a post-hydrolysis fat-to-protein mass ratio; wherein the post-hydrolysis fat-to-protein mass ratio is equal to the pre-hydrolysis fat-to-protein mass ratio within a tolerance of +/−10% of the pre-hydrolysis fat-to-protein mass ratio.

33. The method of claim 20, wherein the hydrolyzed whole grain oats are provided by hydrolyzing starch in the starting whole grain oats; wherein the starting whole grain oats comprise a pre-hydrolysis sugar-to-protein mass ratio; wherein the hydrolyzed whole grain oats comprise a post-hydrolysis sugar-to-protein mass ratio; wherein the post-hydrolysis sugar-to-protein mass ratio is equal to the pre-hydrolysis sugar-to-protein mass ratio within a tolerance of +/−10% of the pre-hydrolysis sugar-to-protein mass ratio.

34. The method of claim 20, wherein the hydrolyzed whole grain oats are provided by hydrolyzing starch in the starting whole grain oats; wherein the starting whole grain oats comprise a pre-hydrolysis beta-glucan-to-protein mass ratio, wherein the hydrolyzed whole grain oats comprise a post-hydrolysis beta-glucan-to-protein mass ratio, wherein the post-hydrolysis beta-glucan-to-protein mass ratio is equal to the pre-hydrolysis beta-glucan-to-protein mass ratio within a tolerance of +/−10% of the pre-hydrolysis beta-glucan-to-protein mass ratio.
